(19) United States
(12) Patent Application Publication
(10) Pub. No.: US 2026/0039458 A1
(43) Pub. Date: Feb. 5, 2026

(54) LATTICE-BASED THRESHOLD SIGNATURE METHOD AND THRESHOLD DECRYPTION METHOD

(71) Applicant: PQShield Ltd, Oxford (GB)

(72) Inventors: Shuichi KATSUMATA, Oxford (GB); Mary MALLER, Oxford (GB); Rafaël DEL PINO, Oxford (GB); Fabrice MOUHARTEM, Oxford (GB); Thomas PREST, Oxford (GB); Thomas ESPITAU, Oxford (GB)

(21) Appl. No.: 19/358,135

(22) Filed: Oct. 14, 2025

Related U.S. Application Data
(63) Continuation of application No. PCT/GB2024/050829, filed on Mar. 27, 2024.

(30) Foreign Application Priority Data
May 4, 2023 (GB) 2306626.9
Oct. 6, 2023 (GB) 2315405.7

(51) Int. Cl. H04L 9/08; H04L 9/32

(52) U.S. Cl. CPC H04L 9/085; H04L 9/3255

(57) ABSTRACT

Lattice-based threshold signature schemes and threshold decryption schemes are described. The threshold signature schemes are described in two or three rounds and are secure under Module Learning with Errors and Module Short integer Solution assumptions. In each of the signature and threshold decryption schemes, blinders may be introduced to shield information about the secret key that may otherwise be leaked by honest participants in the scheme.

### CROSS-REFERENCE TO RELATED APPLICATIONS

This application is a continuation under 35 U.S.C. § 120 of International Application No. PCT/GB2024/050829, filed Mar. 27, 2024, which claims priority to GB Application No. GB2306626.9, filed May 4, 2023, and GB Application No. GB2315405.7, filed Oct. 6, 2023, under 35 U.S.C. § 119 (a). Each of the above-referenced patent applications is incorporated by reference in its entirety.

### TECHNICAL FIELD

The present invention relates to a threshold signature method and threshold decryption method and one or more information processing apparatus for applying such methods.

### BACKGROUND

Recently there has been a National Institute of Standards and Technology (NIST) call for threshold schemes including signatures and encryption schemes. A threshold signature scheme is a special type of multiparty computation that aims to generate a digital signature. A threshold signature assumes that there are N signers, and that any threshold T of the N signers can sign a message but T−1 cannot. In a world without quantum computers there are threshold signature solutions that are both practical and secure in highly adversarial environments. Examples of pre-quantum threshold signature schemes include implementations of e.g. the Schnorr, ECDSA, RSA, or BLS signature schemes. These signature schemes are well developed and include security features such as robustness, identifiable aborts, small round complexity and backward compatibility with existing applications. In a world with sufficiently powerful quantum computers, cryptographic techniques need to be modified because the problems on which pre-quantum cryptographic algorithms are based will become solvable. There are challenges with designing threshold signature schemes for post-quantum cryptography that prior works have struggled to address.

A threshold decryption scheme requires that a message can only be decrypted if T-out-of-N authorities agree to decrypt. While there exist an extensive array of threshold classical encryption schemes, their postquantum counterparts have difficulties with their efficiency. In particular, the Fujisaki-Okamoto transform used in Kyber and other prominent schemes does not easily lend itself to threshold decryption.

Currently there are five common classes of assumptions that are conjectured resistant against quantum computers: multivariate equations, one-way functions, error correcting codes, isogenies, and lattice type assumptions. Nonetheless, there has to date been limited success in building schemes based on these assumptions. Accordingly, there is a desire to formulate a post-quantum threshold signature scheme and a post-quantum threshold decryption scheme.

### SUMMARY

According to a first aspect of the present invention, there is provided a threshold signature method performed by one or more information processing apparatus for generating a signature using a threshold number, T, out of a number N of secret shares generated from a secret, s, wherein the number of secret shares, N, is greater than the threshold number, T, the method comprising:
generating a public matrix, A, and the secret, s;
generating a small noise, e, and a public key, vk=(A, t) including a portion of the public key, t, that is a sum of the small noise, e, with a product of the public matrix, A, and the secret, s;
generating N secret shares, sᵢ, from the secret, s;
for each of the threshold number T of secret shares:
   generating a learning with errors sample, wⱼ;
   generating a commitment, cmtⱼ, that is a hash of at least the generated learning with error sample, wⱼ, and
   making the commitment, cmtᵢ, available in a first round of the signature method and making the learning with errors sample, wⱼ, available in a second round of the signature method;
for each of the T secret shares in a third round of the signature method:
   generating an aggregated commitment, w, by summing the learning with errors samples, wⱼ, across the T secret shares;
   generating a challenge, c, that is a hash of the public key, vk, a message to be signed, msg, and the aggregated commitment, w;
   generating an individual response, zⱼ, based on the challenge, c, the secret share, sⱼ, and an ephemeral randomness used to generate the learning with errors sample, rⱼ; and
   making the individual response, zⱼ, available in the third round;
combining the contributions in respect of the T secret shares in the first, second and third rounds to generate a signature by:
generating an aggregated commitment, w, by summing the learning with errors samples, wⱼ across the T secret shares;
generating an aggregated response, z, by summing the individual responses, zⱼ;
generating a global challenge, c, by hashing the public key, vk, the message to be signed, msg, and the aggregated commitment, w;
generating a hint, h, by:
determining a noisy commitment, y, by subtracting a product of the global challenge, c, and the portion of the public key, t, from a product of the aggregated response, z, and the public matrix, A; and
subtracting the noisy commitment, y, from the aggregated commitment, w, to generate the hint, h; and
outputting a signature comprising the global challenge, c, the aggregated response, z, and the hint, h.

According to a second aspect of the invention there is provided one or more information processing apparatus, each comprising a processor and a storage medium storing computer-readable instructions, wherein the computer-readable instructions are configured to cause the one or more information processing apparatus to perform a method according to the first aspect.

According to a third aspect of the invention there is provided one or more programs that, when executed on one or more information processing apparatus cause the one or more information processing apparatus to perform a method according to the first aspect.

According to a fourth aspect of the invention there is provided a method performed by one or more information processing apparatus for calculating a linear function that includes a product of a secret, s, and a linear function component using a threshold number, T, out of a number N of secret shares generated from a secret, s, wherein the number of secret shares, N, is greater than the threshold number, T, the method comprising:
generating a public matrix, A, and the secret, s;
generating a small noise, e, and a public key, ek, that includes a sum of the small noise, e, with a product of the public matrix, A, and the secret, s;
generating N secret shares, sᵢ, from the secret, s;
for each of a threshold number, T, of the secret shares:
   generating a blinder; and
   generating masked shares of the calculation of the linear function by calculating a first component that is based on a product of the secret share, and the linear function component, and adding or subtracting from the first component a noise and the blinder; and
in an aggregating phase:
summing a combination of the masked share associated with each secret share, whereby the blinders cancel out over the sum of masked shares to allow determination of the linear function.

The linear function may be at least part of one of: a signature function and a decryption function.

In some embodiments, generating the blinder comprises generating a first and a second blinder comprises, for each of T secret shares being used to calculate the linear function generating one of the first blinder and the second blinder as a sum of a first set of T partial blinders, the first set of partial blinders being formed of a partial blinder generated in respect of a secret share for the secret share itself and T−1 partial blinders generated in respect of the secret share for respective ones of the T−1 other secret shares. Some embodiments comprise generating as the other of the first blinder and the second blinder a sum of partial blinders in a second set of partial blinders, the second set being formed of T partial blinders for the secret share including the partial blinder formed in respect of the secret share for the secret share.

Each partial blinder may be generated using a generator function. The generator function may take a seed as an input. The method may comprise for each of N secret shares: 1) generating N seeds including a seed in respect of the secret share and a seed for each of the respective other N−1 secret shares; and 2) distributing the N−1 seeds for other secret shares to the respective other secret shares so that each other secret share receives a single seed, wherein following completion of the two steps for all of the N secret shares, each secret share is associated with 2N−1 seeds including N seeds that were generated in respect of that secret share and N−1 seeds that have been received during the distributions and were generated for the secret share.

In some embodiments generating a blinder comprises generating a first and second blinder. The method may comprises generating masked shares of the calculation of the linear function involves calculating a first component that is based on a product of the secret share, and the linear function component, and adding or subtracting from the first component a noise and the first blinder. The method may comprise summing a combination of the masked share and the second blinder associated with each secret share, whereby the first and second blinders cancel out over the sum of masked shares to allow determination of the linear function.

In other embodiments generating a blinder comprises determining a difference between the first and second blinder.

In some implementations, the N secret shares are secret shares generated from a secret, s, using Shamir secret sharing algorithm based on a polynomial of degree at most T−1.

According to a fifth aspect of the invention there is provided a threshold signature method performed by one or more information processing apparatus for generating a signature using a threshold number, T, out of a number N of secret shares generated from a secret, s, wherein the number of secret shares, N, is greater than the threshold number, T, the method comprising:
generating a public matrix, A, and the secret, s;
generating a small noise, e, and a public key, vk=(A, t) including a portion of the public key, t, that comprises a sum of the small noise, e, with a product of the public matrix, A, and the secret, s; and
generating N secret shares, sᵢ, from the secret, s;
for each of the threshold number T of secret shares:
generating T individual commitments, wᵢ, each comprising one or more learning with errors samples, wⱼ;
aggregating the T individual commitments, wᵢ, to generate an aggregated commitment, W;
generating a challenge, c, that is a hash of at least a message to be signed, msg, and the aggregated commitment, w;
generating T individual responses, zⱼ, based on the challenge, c, the secret share, sⱼ, and one or more ephemeral randomness used to generate the one or more learning with errors sample, rⱼ;
in an aggregating phase:
generating the aggregated commitment, w, by summing the learning with errors samples, wⱼ across the T secret shares;
generating an aggregated response, z, by summing the individual responses, zⱼ;
generating a global challenge, c, by hashing at least the message to be signed, msg, and the aggregated commitment, w;
generating a hint, h, by:
   determining a noisy commitment, y, by subtracting a product of the global challenge, c, and the portion of the public key, t, from a product of the aggregated response, z, and the public matrix, A; and
   subtracting the noisy commitment, y, from the aggregated commitment, w, to generate the hint, h; and
outputting a signature comprising the global challenge, c, the aggregated response, z, and the hint, h.

Some implementations of the method according to the fifth aspect may further comprise: generating a commitment, cmtⱼ, that includes a hash of at least the generated learning with error sample, wⱼ, and making the commitment, cmtᵢ, available in a first round of the signature method and making the learning with errors sample, wⱼ, available in a second round of the signature method; wherein in a third round of the signature method, for each of the T secret shares, the step of generating the aggregated commitment, generating the challenge and generating the individual response are performed and each individual response, zⱼ, is made available in the third round.

In other implementations of the method according to the fifth aspect, generating T individual commitments, wᵢ, comprises for each of the T shares, generating a vector of learning with errors samples, \vec{wᵢ}, and in a signing phase: generating the aggregated commitment, w, comprises generating random weights, β, summing components of each vector of learning with errors samples with the random weights to generate a reduced individual commitment, wⱼ, and then summing the reduced individual commitments, wⱼ across the T secret shares to generate the aggregated commitment, w.

Embodiments of the fifth aspect of the invention may further comprise: for each of the T secret shares generating a first blinder and a second blinder associated with each secret share; wherein generating the individual response, zⱼ, based on the challenge, c, the secret share, sⱼ, and one or more ephemeral randomness used to generate the one or more learning with errors sample, rⱼ comprises adding the first blinder; and wherein generating an aggregated response, z, by summing the individual responses, zⱼ, comprises adding the second blinder associated with each secret share from the corresponding individual response to cancel the first blinder.

In other implementations, the method may further comprise, for each of the T secret shares generating a first blinder and a second blinder associated with each secret share and generating a blinder that is a difference between the first blinder and the second blinder. Generating the individual response, zⱼ, based on the challenge, c, the secret share, sⱼ, and one or more ephemeral randomness used to generate the one or more learning with errors sample, rⱼ may comprise adding the blinder wherein the blinders cancel during the generation of the aggregated response, z.

In such embodiments, generating the first and second blinder may comprise, for each of T secret shares being used to calculate the linear function: generating one of the first blinder and the second blinder as a sum of a first set of T partial blinders, the first set of partial blinders being formed of a partial blinder generated in respect of a secret share for the secret share itself and T−1 partial blinders generated in respect of the secret share for respective ones of the T−1 other secret shares. Such embodiments may comprise generating, as the other of the first blinder and the second blinder, a sum of partial blinders in a second set of partial blinders, the second set being formed of T partial blinders for the secret share including the partial blinder formed in respect of the secret share for the secret share.

Each partial blinder may be generated using a generator function. The generator function may take a seed as an input. The method may comprise for each of N secret shares: 1) generating N seeds including a seed in respect of the secret share and a seed for each of the respective other N−1 secret shares; and 2) distributing the N−1 seeds for other secret shares to the respective other secret shares so that each other secret share receives a single seed, wherein following completion of the two steps for all of the N secret shares, each secret share is associated with 2N−1 seeds including N seeds that were generated in respect of that secret share and N−1 seeds that have been received during the distributions and were generated for the secret share.

In some implementations, generating a blinder based on a seed may comprise generating the blinder based on the output of a pseudorandom function to which the seed is input in combination with a session specific value.

Generating the aggregate commitment, w, may comprise dropping a predetermined number of bits from the sum.

In some implementations, the N secret shares are secret shares generated from a secret, s, using Shamir secret sharing algorithm based on a polynomial of degree at most T−1. In such implementations, generating an individual response for each secret share may comprise taking a product of the challenge, c, a Lagrange coefficient, λⱼ, from the Shamir secret sharing algorithm associated with the secret share, sⱼ, and the secret share, sⱼ, and then combining the product the one or more ephemeral randomness, rⱼ, used to generate the one or more learning with errors sample.

The fifth aspect of the invention may further comprise verifying the signature. Verifying the signature may comprise: generating a signature derived value that is a product of the public matrix, A, and the aggregated response, z, from the signature minus a product of the global challenge, c, from the signature and the portion of the public key, t; generating a new challenge value, c′, by taking a hash of: the public key, vk, the message, msg, and the signature derived value plus the hint from the signature, h; and comparing the new challenge value, c′, to the global challenge, c, to determine if the signature is valid.

Verifying the signature may further comprise comparing a length of the aggregated response, z, and the hint, h, from the signature with one or more threshold. The signature may be determined to be valid if the new challenge value, c′, is equal to the global challenge, c, from the signature and the length of the aggregated response and the hint are less than the one or more threshold.

In some embodiments of the fifth aspect, generating each of the one or more learning with errors sample, wⱼ, comprises sampling the ephemeral randomness, rⱼ, and a small error, eⱼ, and generating the learning with errors sample, wⱼ, by adding the small error, eⱼ, to a product of the public matrix, A, and the ephemeral randomness, rⱼ,

In embodiments that generate a commitment, cmtⱼ, generating a commitment may comprise generating a hash of the generated learning with error sample, wⱼ, and one or more of: the message, msg, and an identifier of the signer, act.

In some embodiments, the following steps are performed by distributed multi-party computation: generating a public matrix, A, and the secret, s; generating a small noise, e, and a public key, vk=(A, t) for t that is a sum of the small noise, e, with a product of the public matrix, A, and the secret, s; and generating N shared secrets from, si, from the secret, s.

According to a sixth aspect of the invention there is provided a threshold decryption method performed by one or more information processing apparatus for decrypting a ciphertext using a threshold number, T, out of a number N of secret shares generated from a secret, s, wherein the number of secret shares, N, is greater than the threshold number, T, wherein the ciphertext has been generated by:
generating a public matrix, A, and the secret, s;
generating a small noise, e, and a public key, ek, that is a sum of the small noise, e, with a product of the public matrix, A, and the secret, s;
generating a first ciphertext portion, ct₁, that is a sum of a first small encryption noise, z₁, with a product of the public matrix, A, and a sampled value, r;
generating a second ciphertext portion, ct₂, that is the sum of an encoded message, a product of the sampled value, r, and the public key, ek, and a second small encryption noise, z₂;
the method comprising:
   generating N secret decryption shares, sᵢ, from the secret, s; for each of a threshold number, T, of the secret decryption shares:
   generating a blinder;
   generating masked decryption shares by forming a product including the secret share, and the first ciphertext portion, ct₁, and combining the product with a sampled noise, e′ and the blinder;
in an aggregating phase:
summing a combination of each masked decryption share; and
decoding the encoded message.

In some embodiments generating a blinder comprises generating a first and second blinder. Generating masked decryption shares may comprises forming a product including the secret share, and the first ciphertext portion, ct₁, and combining the product with the sampled noise, e′ and the first blinder. Summing a combination of each masked decryption share may comprise combining each masked decryption share and the associated second blinder, whereby the first and second blinders cancel over the sum of masked decryption shares.

In other embodiments, the blinder may be a difference between the first and second blinders.

The encoded message may be an encoded extended message, wherein the extended message comprises a message to be encoded and a random string, the ciphertext including a hash of the extended message, whereby following decoding the encoded extended message, the random string from the decoded extended message can be checked against the hash of the extended message to check correct threshold decryption.

In some embodiments, the ciphertext further includes a zero-knowledge proof that comprises an encryption of a zero message under the first ciphertext portion. In such embodiments, the method may comprise, for each of the T secret shares, verifying the zero-knowledge proof before generating the respective masked decryption share, and, in the aggregating phase, verifying the zero-knowledge proof before summing the combination of each masked decryption shares.

Generating the first and second blinder may comprise, for each of T secret shares being used to calculate the linear function: generating one of the first blinder and the second blinder as a sum of a first set of T partial blinders, the first set of partial blinders being formed of a partial blinder generated in respect of a secret share for the secret share itself and T−1 partial blinders generated in respect of the secret share for respective ones of the T−1 other secret shares; generating as the other of the first blinder and the second blinder a sum of partial blinders in a second set of partial blinders, the second set being formed of T partial blinders for the secret share including the partial blinder formed in respect of the secret share for the secret share.

Each partial blinder may be generated using a generator function. The generator function may take a seed as an input. In such embodiments, the method may comprise for each of the N secret shares: 1) generating N seeds including a seed in respect of the secret share and a seed for each of the respective other N−1 secret shares; and 2) distributing the N−1 seeds for other secret shares to the respective other secret shares so that each other secret share receives a single seed, wherein following completion of the two steps for all of the N secret shares, each secret share is associated with 2N−1 seeds including N seeds that were generated in respect of that secret share and N−1 seeds that have been received during the distributions and were generated for the secret share.

The encoded message may be generated using a decisional learning with errors method and decoding the encoded message involves applying a corresponding decoding method. The decisional learning with errors method may be Regev encryption.

The invention may comprise one or more information processing apparatus, each comprising a processor and a storage medium storing computer-readable instructions, wherein the computer-readable instructions are configured to cause the one or more information processing apparatus to perform a method according to any of the preceding aspects.

The invention may comprise one or more programs that, when executed on one or more information processing apparatus cause the one or more information processing apparatus to perform a method according to any of the preceding aspects.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram of components of an example information processing apparatus;

FIG. 2 illustrates steps of a key generation method performed by a central actor;

FIG. 3 shows the relationship between seeds, signers, and blinders in an example in which there are three signers;

FIG. 4a illustrates steps of first and second rounds of a three-round threshold signature method;

FIG. 4b illustrates steps of a third round of a threshold signature method and steps for combining the contributions from three rounds of the threshold signature method to generate a signature;

FIG. 5 illustrates steps for verifying a signature;

FIG. 6a illustrates steps of first and second rounds of a three-round threshold signature method according to a second embodiment;

FIG. 6b illustrates steps of a third round of a threshold signature method and steps for combining the contributions from three rounds of the threshold signature method to generate a signature according to a further embodiment;

FIGS. 7a to 7d illustrate a third embodiment of a three-round threshold signature method that introduces signatures into the second round;

FIGS. 8a to 8c illustrate a fourth embodiment that is a two-round threshold signature scheme;

FIGS. 9a to 9c illustrate a threshold decryption scheme that forms a fifth embodiment;

FIG. 10 illustrates steps of a Zero-knowledge proof used in the fifth embodiment;

FIGS. 11a to 11d illustrate a second threshold decryption scheme that forms a sixth embodiment; and

FIG. 12 is a flowchart showing stages for generating a ciphertext, CT.

### DETAILED DESCRIPTION

Digital signatures are a method of ensuring the authenticity and non-repudiation of electronic documents and messages. They are an important component of secure electronic communication and are widely used in applications such as electronic contracts, financial transactions, and email communication.

The use of digital signatures offers several advantages over traditional paper-based signatures. First, they provide a higher level of security, and it is much more difficult to forge a digital signature than a handwritten signature. Second, they provide a greater level of assurance regarding the authenticity and integrity of the signed document or message, as any changes made to the original document will result in a different signature and thus an invalid signature. Typically digital signatures may be verified by anyone with access to the signer's public key, the message to which the signature was applied, and the signature.

Threshold signature schemes based on lattice assumptions will be described below. Prior signature schemes relying on lattice-based techniques have a feature that the response may depend on the signing key and may thus leak information about signing key. To alleviate this dependency, a commonly used method is the rejection-sampling method, that drops some potential signatures so that the resulting distribution of responses doesn't depend upon secret information. However, rejection sampling methods aren't practical for distributing the computation in a threshold scheme. This is because none of the signers knows the complete signature and the signers are therefore unable to perform the check to reject a signature. More precisely, performing a rejection check in a distributed manner on a signature that is not yet public is a highly complicated task.

The following threshold signature schemes assume that the Module Learning with Errors (MLWE) problem is hard to solve and that the Module Short Integer Solution (MSIS) problem is hard to solve.

### Preliminaries

The signature schemes and encryption/decryption scheme described below may be performed on one or more information processing apparatus such as a server, computer, and/or mobile device. A central actor will be described below. The central actor may be a separate information processing apparatus, such as a server or cloud service, and other steps of the signature scheme may be performed on user devices associated with different signers in the signature scheme. In one example a group of signers in a group may wish to be able to sign a message as long as a threshold number T of the signers in the group contribute to the signature process. The signers may participate in the signature scheme using separate user devices. This applies similarly to a threshold decryption scheme, where each decrypting party may use a separate user device.

In other implementations all the processing may be performed on a single information processing apparatus and there may be a single user. For example, a user may have a signing key associated with a cryptographic asset, such as an asset on a blockchain. The user may wish to keep the signing key secure and resistant to loss. Accordingly, the user may generate shares of the signing key and store them on different storage devices. In this case, the user may sign a document using the storage devices as long as the user has access to at least a threshold number of the devices. Similarly, a malicious actor would need access to a threshold number of the storage devices to apply the signature. In some implementations the storage devices may be drives, such as solid-state drives or the like. All steps of the method in this case could be performed on a single information processing apparatus based on information relating to the key shares stored on the storage devices. The description below will describe potential signers. However, the term ‘potential signer’ or ‘signer’ may be used interchangeably with the term ‘secret share’ because as just described, the method could be performed by a single user in respect of each secret share. Accordingly, the term ‘signer’ should not be interpreted as requiring a separate user or a separate information processing apparatus.

Similarly, where threshold decryption is described, the term ‘user’ should be understood to be interchangeable with the secret share and does not necessarily imply a separate user or a separate information processing apparatus.

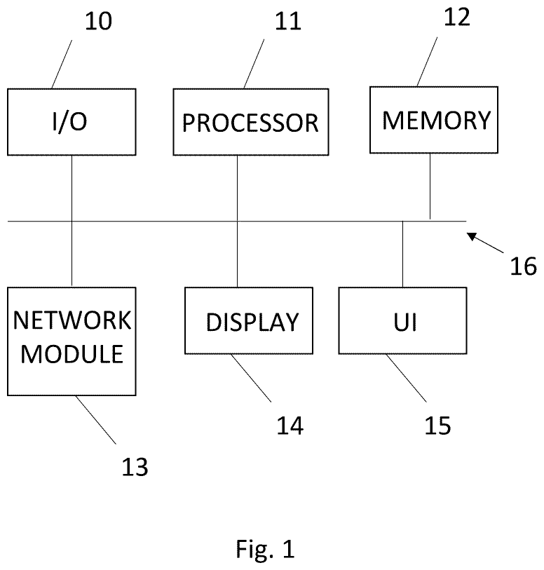

FIG. 1 is a schematic diagram of components of an example information processing apparatus 1 suitable for use in the embodiments described below. The diagram is illustrative and different hardware configurations for information processing apparatus are possible as is well known in the art. The information processing apparatus includes an I/O interface 10, such a USB port, Thunderbolt port, etc. to which an additional device, such as a storage device, could be connected. The information processing apparatus 1 comprises a processor 11, a storage in the form of memory 12, a network module 13, a display 14, and a user interface 15. The network module may allow the information processing apparatus 1 to communicate over a network such as a Wi-Fi network, a mobile telecommunications network, a local area network etc. The user interface may include components such as a keyboard, mouse, camera, etc. The components of the information processing apparatus may communicate with each other over a bus 16. Further components may be provided but are not shown or described. Any of the steps of the subsequently described methods may be performed by computer-readable instructions of one or more programs stored in a storage and executed by a processor on one or more information processing apparatuses.

### First Embodiment

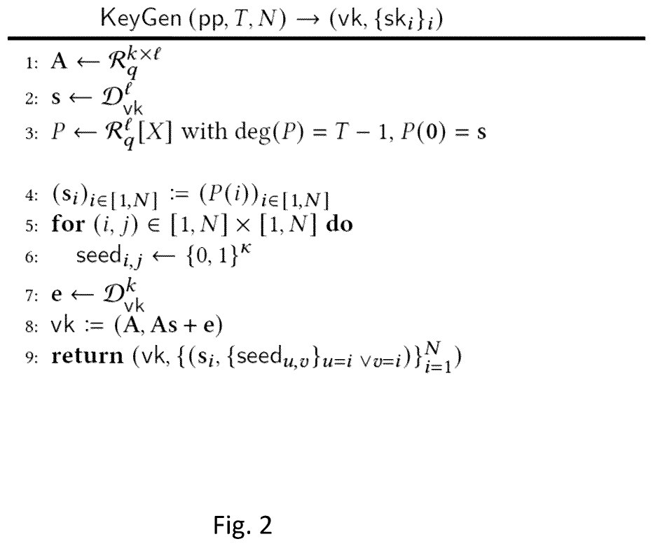

FIG. 2 illustrates steps of a key generation method. At step 1, a central actor generates a uniform matrix, A, over a ring of polynomials, R_{q}. R_{q} is a ring of polynomials modulo q. The Ring, R, is defined for n and q as

$$ℤ / ( {X}^{n} + 1 )$$

and R_{q} is defined as:

$$ℛ / q ℛ$$

The matrix, A, has dimensions of k by 1 and each entry in the matrix is a polynomial of R_{q}.

At step 2, the central actor generates a secret, s, from a distribution D. D is a distribution over R_{q}. The distribution D is labelled Dᵥₖ to distinguish from any other distributions. Accordingly, secret, s, is a sampled polynomial modulo q. In some examples, a discrete Gaussian distribution is used. A discrete Gaussian distribution about a point v with a standard deviation of σ is given by:

$${𝒟}_{v , σ} ( z ) = \frac{exp ( - \frac{{‖ z - v ‖}^{2}}{2 {σ}^{2}} )}{{\sum }_{{z}^{′} ∈ {ℛ}^{k}} exp ( - \frac{{‖ {z}^{′} - v ‖}^{2}}{2 {σ}^{2}} )}$$

In a case in which the center is zero, we will use the terminology D_{σ} below.

At step 3, the central actor uses Linear Shamir Secret Sharing to generate N secret shares, sᵢ. In accordance with this method, a polynomial, P, with degree T−1, is generated over R_{q}. T is the threshold number of shares required to perform the signature. The threshold number of shares, T, may be considered, in some examples, to be the number of active signers required to generate the signature. The polynomial at zero is equal to the selected secret s i.e. P(0)=s.

At step 4, the Shamir Secret sharing is continued, and N secret shares are generated from the polynomial, P. The value N is the number of secret shares to be generated where N is greater than or equal to T the threshold number of secret shares required to complete the signature process. The N secret shares are provided to a set of potential signers, S.

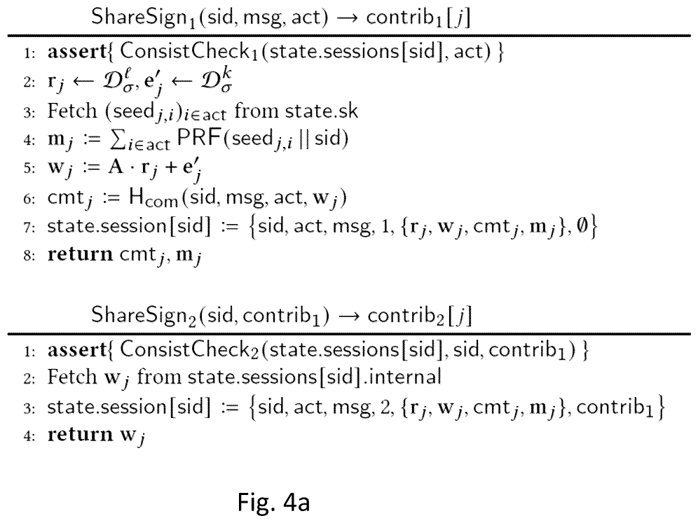

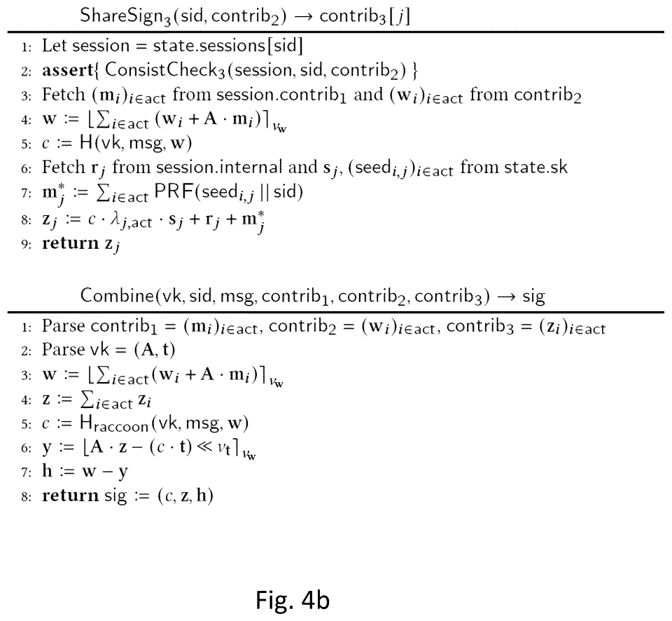

Reconstruction of the polynomial P will be performed later, as described below in connection with FIG. 4b. The reconstruction is performed using Lagrange polynomials. For i∈S, we define:

$${λ}_{i , S} := {\prod }_{j ∈ S \backslash \{ i \}} \frac{- j}{i - j} .$$

where λ_{i,S} is a Lagrange coefficient. A set of evaluation points, E, is defined each having coordinates xᵢ, yᵢ for each of N different values of i (corresponding to the N secret shares). yᵢ=P(xᵢ) In this case

$$s = {\sum }_{i ∈ S} {λ}_{i , S} \cdot {y}_{i} .$$

Accordingly, during the key generation process, each potential signer receives a respective secret share sᵢ=yᵢ.

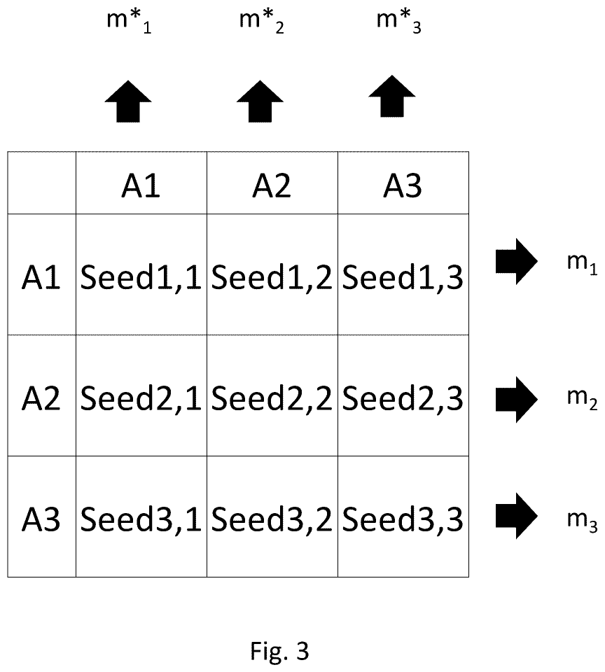

At steps 5 and 6, shared seeds, which are random binary values of length k are generated by each potential signer and distributed pair-wise. That is to say that each of the N potential signers generates or receives a seed for itself and a separate seed for each other potential signer. Each potential signer sends each other potential signer an associated seed. The generated seeds are illustrated in FIG. 3 for a case in which N=3. A potential signer identifier (A1 to A3) is shown on the edges of the matrix corresponding to each potential signer. Seed1,1 is generated in respect of potential signer Al and is stored locally in association with a first secret share but not distributed to any other potential signer. Likewise, Seed2,2 is generated by potential signer A2 and stored locally and Seed3,3 is generated by potential signer A3 and stored locally. The other seeds are generated and distributed to the respective potential signers. So, for example, potential signer A2 will receive Seed1,2 from potential signer A1 and Seed3,2 from potential signer A3. Correspondingly, potential signer A2 will generate Seed2,1 and distribute it to potential signer A1 and generate Seed2,3 and distribute it to potential signer A3.However, potential signer A2 does not learn seed values that are not either generated by potential signer A2 (i.e. Seed 2,1, Seed 2,2 and Seed 2,3) or received from the other potential signers (i.e. Seed 1,2 and Seed 3,2) In other words, in this example, potential signer A2 does not know Seed1,1, Seed3,1, Seed1,3 and Seed3,3. The same applies mutatis mutandis to the other potential signers A1 and A3.

In this example, the shared seeds are generated by the potential signers. However, the skilled person will appreciate that the shared seeds could equally be generated by the central actor and distributed appropriately.

Returning to FIG. 2, in step 7 the central actor samples a small noise (or error), e, from the distribution D.

At step 8, the central actor generates a public key, vk, that is A, As+e. The seeds are generated and distributed as described above. Otherwise, the Matrix, A, and the public key, vk, are made publicly available parameters by the central actor. The secret, s, is destroyed by the central actor after the key shares and public key are generated. Similarly, the small noise (error), e, is destroyed after the public key is generated.

The signature scheme proceeds in three rounds. In some implementations each round will be time limited such that each of a threshold number of active signers (hereinafter ‘signers’) of the N potential signers should complete the specified steps within the time limit. If the threshold number of signers do not complete the required steps for a round within the time limit, the signature method may be aborted. In a first round, each signer generates and makes available a commitment, cmtⱼ, and a blinder, mⱼ. In a second round, each signer makes available an LWE commitment, wⱼ. In a third round, each signer makes available a response zⱼ. The central actor can then generate a signed message based on the available information. Each round may be completed sequentially in order to maintain security of the signature scheme. At the end of each round the signers may check that the round has been completed before initiating steps in the subsequent round.

The first round of making available a commitment, cmtⱼ, and a blinder, mⱼ, is shown at the top of FIG. 4a. In step 1, checks are made for the session identifier, which changes with each iteration of the signature method. The session identifier may be implemented as a counter or generated randomly for each iteration of the signature method.

In step 2 of the first round, each signer samples a small ephemeral randomness rⱼ and a small noise (or error), e′ⱼ. Each sample is taken from a distribution across R_{q}, D_{σ}, as described above.

In step 3, each signer retrieves seeds that it has generated and/or received during the key generation phase and in step 4 generates a row blinder mⱼ. The row blinder, mⱼ, is generated based on the seeds associated with the threshold T signers involved in the threshold signature method. At a simple conceptual level, looking at the particular matrix of Seeds shown in FIG. 3 and considering signer A2, signer A2 would sum along the row including Seed2,2 to generate a blinder that is the sum of the row. Accordingly, the signer A2 would generate the first blinder based on the shared seed generated in respect of the secret share for itself (Seed2,2) and T−1 shared seeds that were generated in respect of T−1 other signers in connection with that signer (Seed2, 1 and Seed2,3). Returning to step 3 of the top part of FIG. 4a, each Seed is used as a seed for a pseudorandom function (PRF) along with a session identifier, sid. As the session identifier changes between sessions the values of the blinders also changes thereby improving security.

In step 5, a Learning with Errors (LWE) commitment, wⱼ, is generated based on the lattice A generated in the key generation phase and the generated small ephemeral randomness, rⱼ, and small noise (error), e′ⱼ, generated by the signer. The LWE commitment, wⱼ, is the sum of the small noise (error), e′ⱼ and a product of the uniform matrix, A, and the generated small ephemeral randomness, rⱼ.

In step 6, a hash commitment, cmtⱼ, is generated. Each signer generates a hash using a function H_{com} based on the session id (sid), message to be signed (msg), identity of the signer, act, and generated LWE commitment (wⱼ). The Hash function H is labelled ‘com’ to distinguish from other hash functions. The Hash function may, in some examples, be selected from the four recommended hash functions in NIST special publication 800-185: SHA-3 Derived Functions: cSHAKE, KMAC, TupleHash and Parallel Hash.

The commitment, cmtⱼ, and row blinder, mⱼ, of each signer is made available to each other signer at the end of the first round in a contribution, contrib₁.

The second round of the signature method is illustrated in the lower portion of FIG. 4a. In a first step of the second round, a check is made to ensure that the contributions from the first round are complete and that the session identifier is consistent among the contributions, contrib₁ from the first round.

In the remaining steps of the second round the signers retrieve the LWE commitment, wⱼ, that each generated in the first round and make their LWE commitment, wⱼ, available to the other signers in a second contribution, contrib₂.

The top portion of FIG. 4b shows the third round of the signature method. In steps 1 and 2, the session ID is checked and it is checked that the first and second rounds were successfully completed with contributions received from each of the signers. In step 3, each signer retrieves the row blinders, mⱼ, that were made available at the end of round 1.

In step 4, each signer calculates an aggregated commitment, w, which is obtained by summing, across the signers, the LWE commitments, wⱼ, made available at the end of the second round in combination with a product of the row blinders, mᵢ, and the uniform matrix, A. The aggregated commitment, w, is subjected to bit dropping in accordance with a parameter, ν_{w}, which is a parameter that is made openly available to signers using the signature method. The bit dropping serves several purposes. The dropping of bits serves to make the commitment shorter and thus the resulting signature shorter and also serves to improve the resistance of the scheme from direct forgery attacks by hiding the ephemeral randomness in the aggregated commitment, w. The bit dropping is similar to the bit dropping technique that is used in connection with CRYSTALS-Dilithium.

At step 5, each signer calculates a global challenge, c, that is a hash of the public key, vk, the message, msg, and the aggregated commitment, w. Although not shown in FIG. 4b, the hash function used is H_{raccoon}. The Hash function H is labelled ‘raccoon’ to distinguish from other hash functions, such as the earlier ‘com’ hash function. Further details of the hash function are given further below.

In steps 6 and 7, a column blinder m*ⱼ is calculated. This column blinder is calculated in an analogous manner to the row blinder described above. The column blinder, m*ⱼ, is generated based on the seeds associated with the threshold T signers involved in the threshold signature method. Returning to the particular example in FIG. 3 and considering signer A2, signer A2 would sum along the column including Seed2,2 to generate a blinder that is the sum of the column. That is to say that the column blinder is based on each of T of the N shared seeds generated in respect of the signer (i.e. Seed1,2, Seed2,2, Seed3,2). Returning to steps 6 and 7, each Seed is used as a seed for a pseudorandom function (PRF) along with a session identifier, sid. Many PRF could be used for the signature scheme. In some embodiments, the PRF is based on HMAC (details of which are described in IETF RFC 2104) with SHA-256. In other examples, a PRF derived from SHAKE: NIST publication FIPS PUB 202: SHA-3 Standard: Permutation-Based Hash and Extendable-Output Functions may be used. The output of these techniques may be a bit string that needs to be mapped to a mathematical object, such as a vector or matrix. Techniques for performing this mapping are known in the art from, for example, schemes such as Dilithium, Kyber and Falcon. As the session identifier changes between sessions, the values of the column blinders also change therefore change improving security.

At step 8, each signer generates an individual response zⱼ. The individual response is the sum of three components. The first component is a product of the global challenge, c, the signer's Lagrange coefficient, λ_{j,act}, and the signer's secret share, sⱼ. The second component is the ephemeral randomness, rⱼ, that was generated in the first round. The third component is the generated column blinder, m*ⱼ.

At step 9, each signer makes available their individual response, zⱼ, to the other signers and the central actor.

The method shown in the lower part of FIG. 4b shows a combine operation performed by the central actor. In steps 1 and 2, the central actor obtains each of the row blinders, mᵢ, LWE commitments, wᵢ, and individual responses, zᵢ, generated by the signers, i. The central actor also obtains the public key, vk=(A,t), generated in the key generation phase. Here it is noted that t=As+e.

At step 3, the central actor generates an aggregated commitment, w. This step is the same as was performed by each of the signers in step 4 of the third round described above. The aggregated commitment, w, is obtained by summing, across the signers, the LWE commitments, wᵢ, made available at the end of the second round in combination with a product of the row blinders, mᵢ, and the uniform matrix, A. The aggregated commitment is subjected to bit dropping in accordance with a parameter, ν_{w}, which is a parameter that is made openly available to signers using the signature method.

At step 4, the central actor generates an aggregated response, z, by summing each of the individual responses, zᵢ, made available at the end of the third round.

At step 5, the central actor generates a global challenge, c. The global challenge, c, is generated by hashing the public key, vk, the message to be signed, msg, and the aggregate commitment, w, calculated in step 3. The central actor generates the hash using a function H_{raccoon}. The Hash function H is labelled ‘raccoon’ to distinguish from other hash functions, such as the earlier ‘com’ hash function. The Hash function may, in some examples, be selected from the four recommended hash functions in NIST special publication 800-185: SHA-3 Derived Functions: cSHAKE, KMAC, TupleHash and Parallel Hash. In a further example, SHAKE described in NIST publication FIPS PUB 202: SHA-3 Standard: Permutation-Based Hash and Extendable-Output Functions may be used. The Hash functions H_{com} and H_{raccoon} should preferably be different, at least in the parameters used. The selection of different hash functions has the effect of domain separation and may improve the security of the signature scheme.

In step 6, a noisy commitment, y, is generated by the central actor. The noisy commitment is generated from the difference of two components. The first component is a product of the uniform matrix, A, and the aggregated response, z. The second component is a product of the global challenge c, calculated in step 5, and t=As+e generated in the key generation phase. The calculated difference is subjected to bit shifting to multiply the value by two to the power νₜ. This is a renormalization to allow for bit dropping. The noisy commitment is then subject to bit dropping by ν_{w} bits. Both νₜ and ν_{w} are public parameters.

At step 7, a hint, h, is generated by the central actor. The hint is a difference between the aggregated commitment, w, and the noisy commitment, y.

At step 8, the signature of the message, msg, is provided. The signature includes three components: the global challenge, c, the aggregated response, z, and the hint, h.

Public parameters νₜ and ν_{w} are referred to above. In general, it is desirable to maximise the value of νₜ and ν_{w} in order to drop more bits. This has the beneficial effect of shortening the bit sizes. However, security of the scheme against direct forgery attack decreases with increased νₜ and ν_{w}. Accordingly, while different values of νₜ and ν_{w} can be selected, in some examples, they may be chosen as follows:

$${v}_{w} = ⌊ \sqrt{T} \cdot {σ}_{w} ⌋$$

$$and$$

$${v}_{t} = ⌊ \sqrt{T} \cdot {σ}_{w} / ‖ c ‖ ⌋$$

T is the threshold number of users as identified above, σ_{w} is the standard deviation of the distribution used to select the error when generating the public key, and c is the global challenge. In a typical implementation, around 80% of the bits may be dropped.

### Verifying the Signature

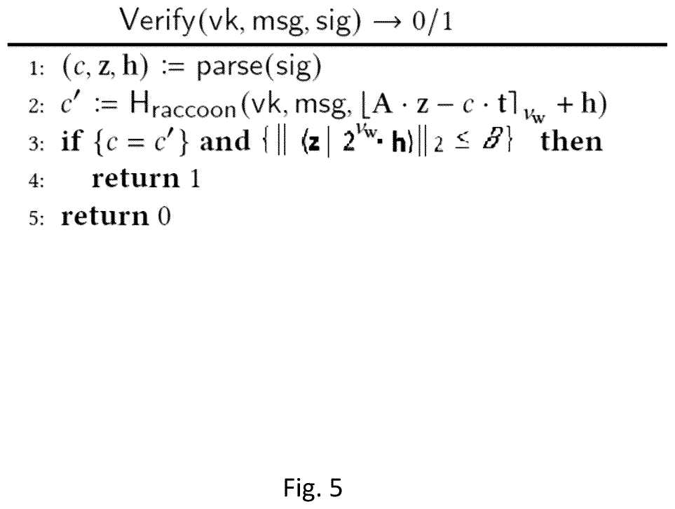

Steps for verifying the signature are shown in FIG. 5. A party verifying the signature is assumed to also have a copy of the message, msg, which has been signed and against which the signature is being checked and a copy of the public key, vk. Other public parameters described above, including ν_{w}, νₜ, and the hash function, H_{raccoon}, are also available to the verifying party. The party verifying the signature does not need to be (but could be) a member of the group of signers that were involved in generating the signature.

At step 2, the party verifying the signature generates a signature derived value. The signature derived value is a product of the uniform matrix, A, and the aggregated response, z, minus a product of the global challenge, c, and t=As+e from the public key. The signature derived value is subjected to bit dropping of ν_{w} bits and has the hint, h, added to it. A new challenge value c′ is calculated by taking a hash of: the public key, the message, and the signature derived value after bit dropping and addition of the hint.

In step 3, the party verifying the signature determines whether the new challenge value, c′, is equal to the challenge value, c, in the signature. A further check is performed to see that a vector formed of a concatenation of the aggregated response, z, and a product of 2 to the power ν_{w} and the hint, h, is shorter than, B. The shortness of the vector relates to the module short integer solution (M-SIS) problem. B, referred to in the figures as the two-norm bound on the signature, is set larger than zero and less than q (recalling from above that the uniform matrix is a set of polynomials of modulo q). B should be set to a large enough value to allow the M-SIS problem to allow the signer to realistically find a signature. On the other hand, B should be set small enough to provide security with respect to the M-SIS problem. More information on setting a suitable value of B may be found, for example, in Chitchanok Chuengsatiansup, Thomas Prest, Damien Stehle, Alexandre Wallet, and Keita Xagawa. ModFalcon: Compact signatures based on module-NTRU lattices, ASIA ACCS 20, pages 853 to 866.

In one example:

$$B + {2}^{{v}_{w} - 1} \sqrt{kn} \leq {min}_{ℓ n \leq m \leq ( k + ℓ ) n} ( {q}^{\frac{kn}{m}} \cdot {δ}_{β}^{m} ) ,$$

$$where {δ}_{β} = {( \frac{{( πβ )}^{1 / β} \cdot β}{2 π e} )}^{1 / ( 2 ( β - 1 ) )} .$$

In which l, k, q are defined in the Module Short Integer Solution problem. q is the modulo of the Ring, k and l are dimensions of the Ring. n is the order of polynomials of the Ring (see definition above). The parameter “β” is related to an algorithm called BKZ (block Korkine-Zolotarev). The best known approach to solve MSIS is via the BKZ algorithm. β is a parameter of the BKZ algorithm. The success probability and the running time of BKZ are both increasing functions of β. Accordingly, the equation above guarantees that BKZ can only succeed with reasonable probability if β is set large enough. Accordingly, β can be set so that the running time required for BKZ to break the security of the signature scheme is too large to be tractable and the value B can be determined accordingly.

The Module Short Integer Solution is defined as:

$$Given A ← {ℛ}_{q}^{k \times ℓ} , find an element s ∈ {ℛ}^{k} such that :$$

$$( 0 < {‖ s ‖}_{2} \leq β ) ⋀ ( A \cdot s = 0 mod q ) .$$

In steps 4 and 5, if both conditions in step 3 are satisfied, the signature is verified and the method returns a value 1 confirming the signature. Otherwise, in step 5, the method returns 0 indicating that the signature is invalid.

### Second Embodiment

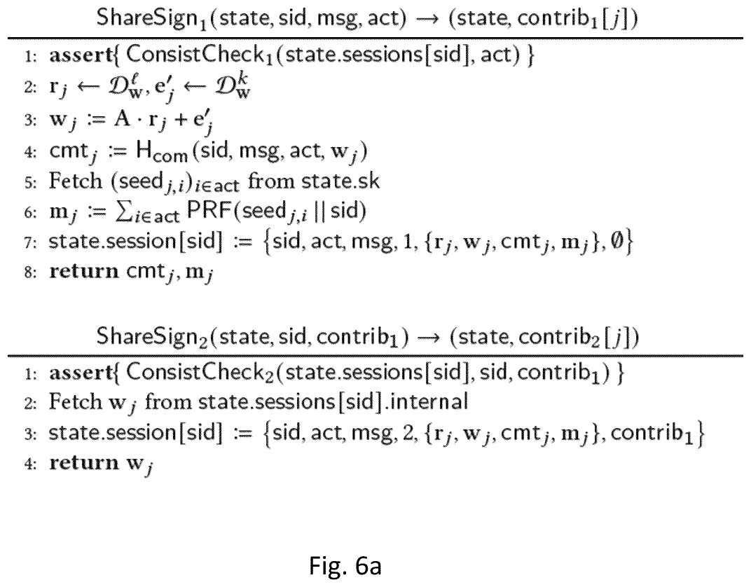

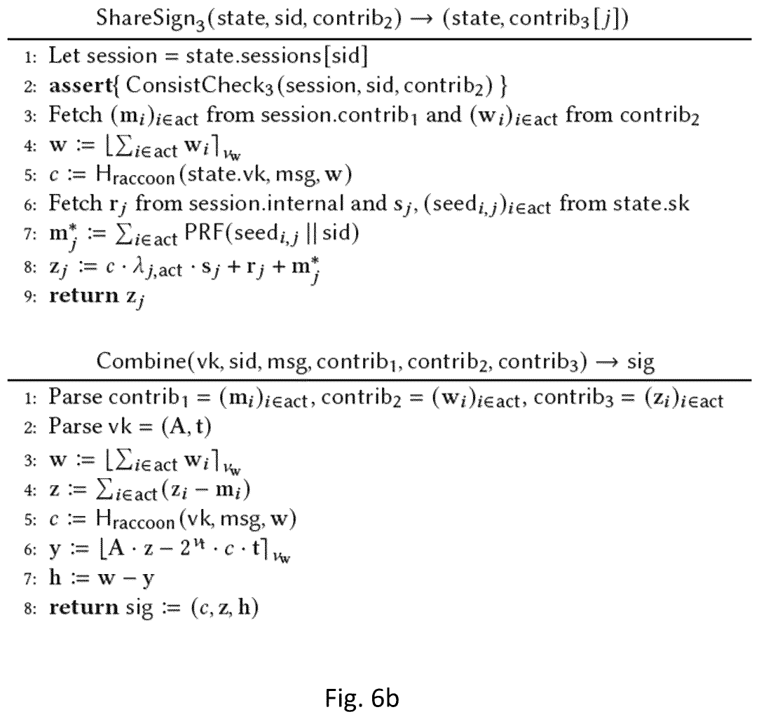

FIG. 6a illustrates steps of first and second rounds of a threshold signature method according to a further embodiment. The key generation steps for this further embodiment are the same as those shown and described with respect to FIG. 2 above and the method for verifying the signature is also unchanged. There are many similarities between the second embodiment and the embodiment described above in connection with FIGS. 4a and 4b. Accordingly only differences will be described. In the first round, the notation has changed from D_{σ}¹ to D_{w}¹. However, the sampling of a small ephemeral randomness rⱼ and a small noise (or error), e′j, are the same between both methods. Accordingly, there are no differences in the first round compared to the previously described embodiment.

The lower part of FIG. 6a shows the second round of the further embodiment. Again, there are no differences in the second round compared to the previously described embodiment.

FIG. 6b illustrates steps of a third round of a threshold signature method and steps for combining the contributions from three rounds of the threshold signature method to generate a signature according to a further embodiment. At step 4 of the third round shown in the in upper part of FIG. 6b, each signer calculates an aggregated commitment, w, which is obtained by summing, across the signers, the LWE commitments, wⱼ, made available at the end of the second round. The aggregated commitment, w, is subjected to bit dropping in accordance with a parameter, ν_{w}, which is a parameter that is made openly available to signers using the signature method. Accordingly, compared to the earlier embodiment, the term that is a product of the row blinders, mi, and the uniform matrix, A, is not included.

In the combining process shown in a lower part of FIG. 6b, at step 3, each signer calculates an aggregated commitment, w, which is obtained by summing, across the signers, the LWE commitments, wⱼ, made available at the end of the second round. The aggregated commitment, w, is subjected to bit dropping in accordance with a parameter, ν_{w}. Accordingly, compared to the earlier embodiment the term that is a product of the row blinders, mi, and the uniform matrix, A, is not included.

In step 4, the central actor generates an aggregated response, z, by summing a difference between each of the individual responses, zᵢ, made available at the end of the third round and the row blinder, mᵢ, made available at the end of the first round. The difference in this step compared to the previously described method is the subtraction of the row blinder, mᵢ.

It is noted that in step 6, the term 2 to the power νₜ is equivalent to the bit shifting described previously in connection with the same step in FIG. 4b.

The differences between the previously described embodiment and the further embodiment serve to reduce the size of the aggregated response, z, making the signature method more efficient.

The above embodiments are to be understood as illustrative examples of the invention. Further embodiments of the invention are envisaged. For example, in the description above, the key generation steps shown in FIG. 2 are performed by a trusted central actor. In other implementations, a distributed key generation method could be used. Such distributed key generation could be performed using known techniques for secure multiparty computation. By distributing the key generation either among the signers, where the signers represent different devices, or among a plurality of other information processing apparatus, the overall security of the scheme may be improved but at the expense of additional computational load.

In the examples above, the blinders are calculated based on pseudo-random function taking the shared seeds and a session identifier as an input. However, the use of the pseudorandom function and a session identifier is optional. The blinders could be generated by simply using sums of the shared seeds. In this case, the blinders would not vary with each iteration of the signature method. The session identifier described varies with each performance of the signature scheme and changes the blinders between each performance of the signature scheme. In the embodiments described above, the session identifier may be a counter or may be randomly generated for each session.

The examples described above include the use of blinders. In further examples, the blinders may be omitted. Omitting the generation of each of the row and column blinders from the described methods, omitting publishing of the column blinders in the first round, and otherwise omitting terms relating to the row or column blinders where they appear in the method, such as during generation of the aggregated commitment, will result in a functioning threshold signature method. The blinders are included in the threshold signature method described above for security considerations. More particularly, the blinders shield information about the secret key that may be leaked by honest participants in the signature method when returning the secret share in the individual responses, zⱼ. In the examples above, two sets of blinders are generated in a T-out-of-T threshold fashion such that

$${\sum }_{j ∈ act} {m}_{j} = {\sum }_{j ∈ act} {m}_{j}^{*}$$

mⱼ is publicly shared at the end of round 1 while m*ⱼ can only be computed by actor j. Accordingly, each commitment wⱼ is hidden behind an additive column blinder m*ⱼ during the computation of individual responses zⱼ. To preserve correctness during signature verification, the blinder is compensated for by adding mⱼ to each LWE commitment, wⱼ.

The calculation of m and m* described above is symmetric as explained above in connection with FIG. 3. Accordingly, the use of row and column blinders described above can be swapped (i.e. the row blinder used where the column blinder was used and vice versa).

### Third Embodiment

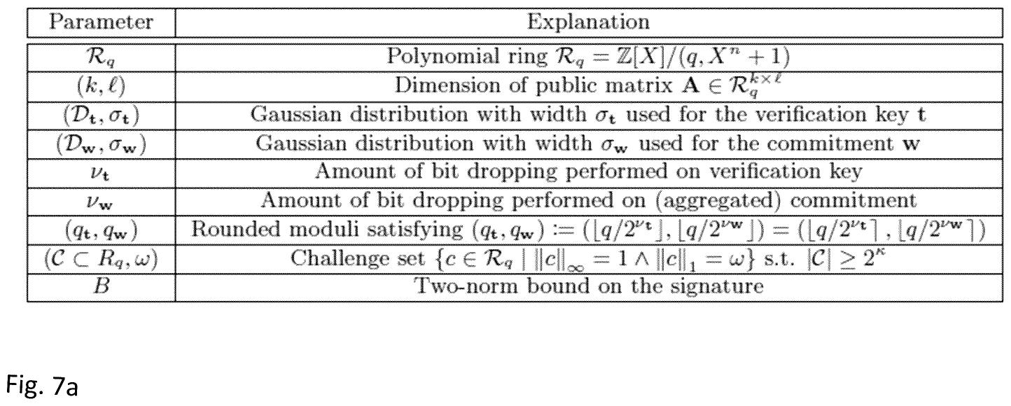

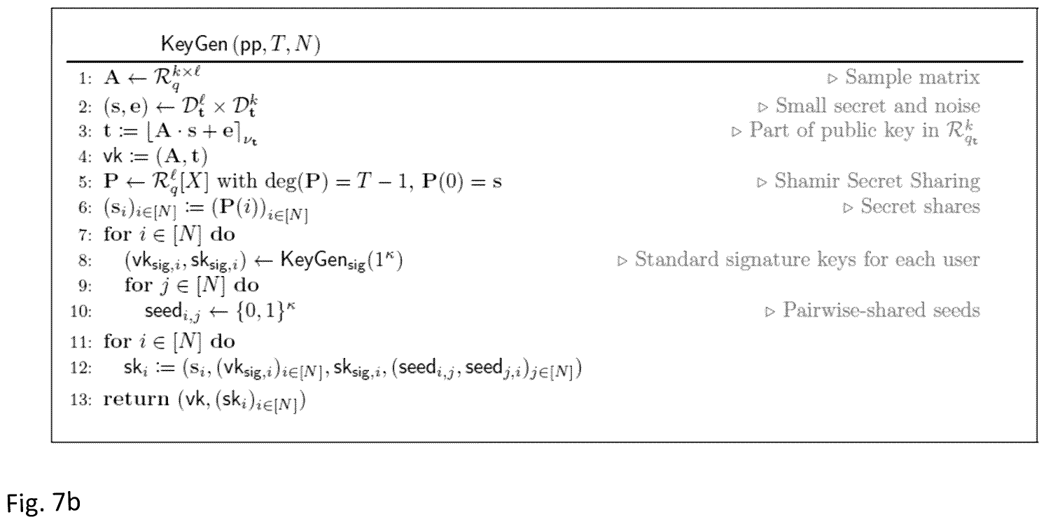

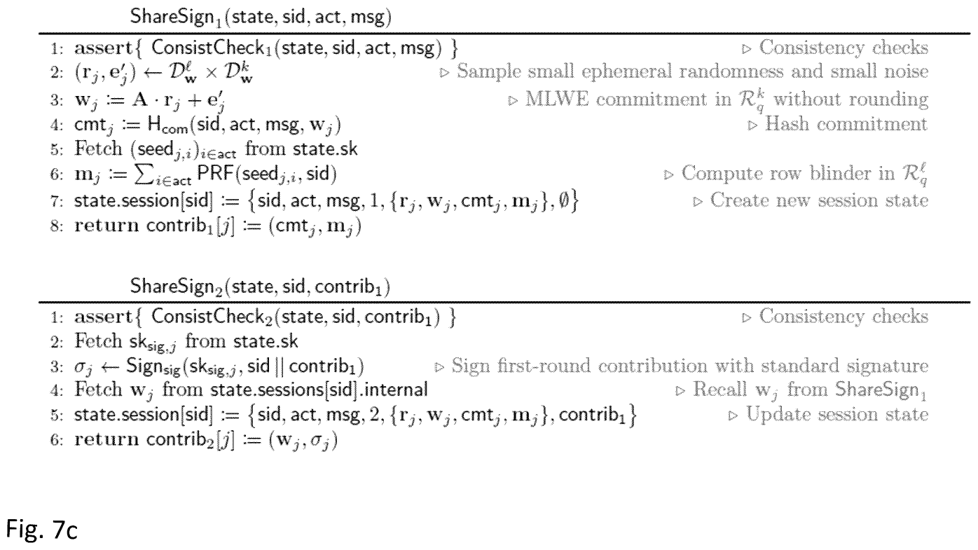

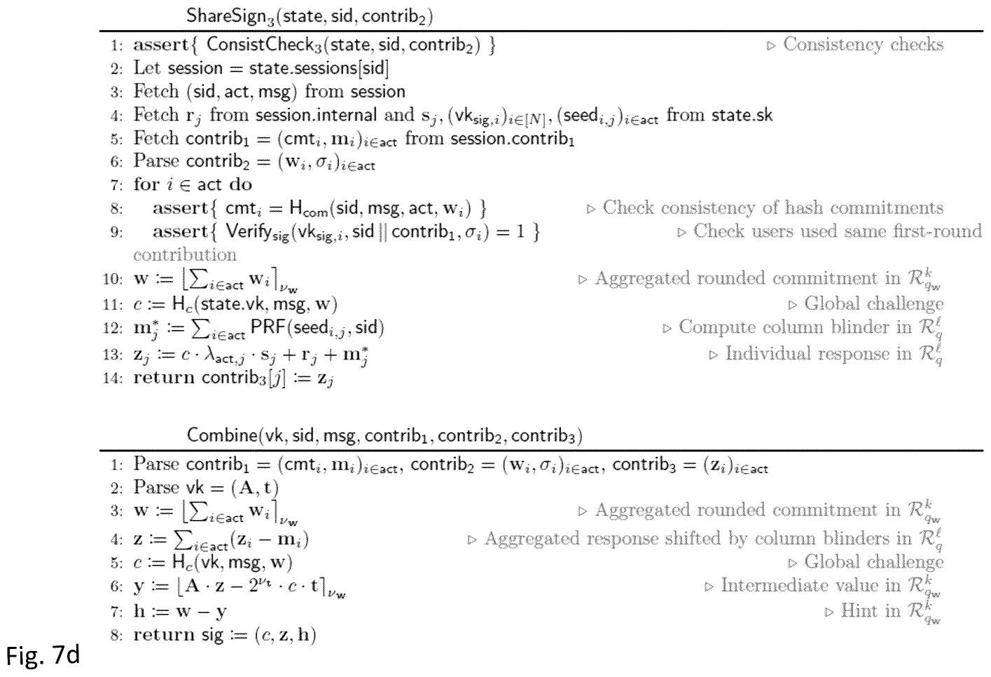

FIGS. 7a to 7d show a further embodiment of the threshold signature scheme.

FIG. 7a is a chart showing a glossary of terms used in FIGS. 7b to 7d.

The third embodiment is very similar to the second embodiment and only differences will be described. The third embodiment introduces a signing step within the signature scheme in order to prove that each party has seen the same contribution in the first round of the signature scheme as will now be described.

FIG. 7b shows a key generation step corresponding to the key generation step described in connection with FIG. 2. The notation varies slightly from FIG. 2, but a difference is in steps 7 and 8 where a public/private signature key pair is generated for each user device using a key generation function. Steps 12 and 13 also vary from corresponding step 9 in FIG. 2 because the key generation step now returns a private signature key in addition to the secret share and the seeds to each device.

Correspondence between the similar steps in FIG. 7b and FIG. 2 is set out below:

Step 1 in FIG. 7b corresponds to step 1 in FIG. 2.

Step 2 in FIG. 7b corresponds to steps 2 and 7 in FIG. 2.

Step 3 and 4 in FIG. 7b correspond to steps 8 in FIG. 2 and define the public key, vk, with a slightly different notation.

Step 4 and 6 in FIG. 7b are identical to steps 4 and 5 in FIG. 2.

Steps 9 and 10 in FIG. 7b correspond to steps 5 and 6 in FIG. 2.

FIG. 7c shows the first two rounds of the signature scheme. Aside from minor differences in terminology, which are immaterial, the steps of the first round (ShareSign₁) in FIG. 7c are step-by-step identical to the corresponding first round method (ShareSign₁) illustrated and described with reference to FIG. 6a. Accordingly, no additional description of this process is provided.

The lower part of FIG. 7c shows the second round of the signature scheme. This second round is very similar between the scheme shown in FIG. 6a and the scheme shown in FIG. 7c. However, an additional step, step 3 in FIG. 7c, is provided. In steps 2 and 3, each device signs, using the received private signature key from the key generation stage, a concatenation of the session id and the contributions received in the first round. In some embodiments, one or more of: the identity of the signing parties, act, and the message, msg, may additionally be included in the signature. The contributions in the first round are the set of all contributions received including the contribution generated at the device. In other words, contrib₁ is all the contributions from each device in the signing set with index j, contrib₁[j]. The purpose of this signature is to prove that each device has seen the contributions from the first round and to allow verification that those contributions were the same.

In step 6 of ShareSign2 in FIG. 7c, the returned contribution includes the signature, σⱼ, generated in step 3. Otherwise, this step is the same as step 4 in FIG. 6a.

Step 1 of ShareSign2 in FIG. 7c corresponds to step 1 in ShareSign2 of FIG. 6a.

Steps 4 and 5 of ShareSign2 in FIG. 7c correspond to steps 2 and 3 of FIG. 6a.

FIG. 7d illustrates steps of a third round of a threshold signature method (ShareSign₃) and steps for combining the contributions from three rounds of the threshold signature method to generate a signature according to a further embodiment. This process is labelled Combine in FIG. 7d.

In step 1, some consistency checks are performed to ensure that the session state indicates that the ShareSign3 process should be performed in accordance with the session state associated with a session id, sid, and having contributions, contrib₂, from the previous round of the signature scheme.

In step 2, the session state is recovered, which includes the information included in the session state in step 5 of ShareSign₂ shown in FIG. 7c. In particular, in step 3, the session id, sid, the identity of the actor, act, and the message being signed, msg, are retrieved from the session state on the device performing ShareSign₃.

In step 4, the ephemeral randomness, rⱼ, key share, sⱼ, the public signature keys of the parties signing in the threshold signature group, and seeds for the parties signing in the signature group are obtained.

The combined contributions from the previous rounds, contrib₁ and contrib₂, are also retrieved.

In steps 7 to 9 various checks are performed. In particular, each device checks the consistency of the hash commitments. The commitment from the first round included a hash commitment, cmtⱼ, that was generated using a commitment hash function, H_{com}. The second-round contribution, contrib₂, contains the LWE commitment, wⱼ. Accordingly, the hash commitment, cmtⱼ, can be checked to see that the commitment did not change between the first and second round. In step 9, the signatures generated in the second round, ShareSign₂, are checked using a signature verification function and public keys of the signing parties. This verifies that the other user devices had the same contributions, contrib₁, from the first round.

At step 10 of the third round shown in the in upper part of FIG. 7d, each signer calculates an aggregated commitment, w, which is obtained by summing, across the signers, the LWE commitments, wᵢ, made available at the end of the second round. The aggregated commitment, w, is subjected to bit dropping in accordance with a parameter, ν_{w}, which is a parameter that is made openly available to signers using the signature method. Accordingly, compared to the first embodiment, the term that is a product of the row blinders, mᵢ, and the uniform matrix, A, is not included. This is the same as the method described with respect to FIG. 6b.

At step 11, each signer calculates a global challenge, c, that is a hash of the public key, vk, the message, msg, and the aggregated commitment, w. Although not shown in FIG. 7d, the hash function used is H_{c}. As with H_{raccoon} described in connection with the previous embodiments, the Hash function H is labelled ‘c’ to distinguish from other hash functions, such as the earlier ‘com’ hash function. The hash functions may be selected from the examples given in connection with the earlier embodiments.

In step 12, a column blinder m*ⱼ is calculated. This column blinder is calculated in an analogous manner to the row blinder described above. The column blinder, m*ⱼ, is generated based on the seeds associated with the threshold T signers involved in the threshold signature method. Each Seed is used as a seed for a pseudorandom function (PRF) along with a session identifier, sid. Many PRF could be used for the signature scheme. In some embodiments, the PRF is based on HMAC (details of which are described in IETF RFC 2104) with SHA-256. In other examples, a PRF derived from SHAKE: NIST publication FIPS PUB 202: SHA-3 Standard: Permutation-Based Hash and Extendable-Output Functions may be used. The output of these techniques may be a bit string that needs to be mapped to a mathematical object, such as a vector or matrix. Techniques for performing this mapping are known in the art from, for example, schemes such as Dilithium, Kyber and Falcon. As the session identifier changes between sessions, the values of the row blinders also change therefore change improving security.

At step 13, each signer generates an individual response zⱼ. The individual response is the sum of three components. The first component is a product of the global challenge, c, the signer's Lagrange coefficient, λ_{j,act}, and the signer's secret share, sⱼ. The second component is the ephemeral randomness, rⱼ, that was generated in the first round. The third component is the generated column blinder, m*ⱼ.

At step 14, each signer makes available their individual response, zⱼ, to the other signers and the central actor in contrib₃[j].

The Combine method performed by the central actor is shown in the lower part of FIG. 7d. The method is identical to the method described in connection with the Combine method shown in the lower part of FIG. 6b aside from the change in notation from H_{raccoon} to H_{c}. Accordingly, the description of the method is not repeated.

q_{νt} and q_{νw} are defined in FIG. 7a as rounded moduli satisfying various conditions in accordance with the bit dropping parameter. These terms appear in FIGS. 7b to 7d in connection with steps involving bit dropping and simply serve to define the set of polynomials as explained in the comments in the figures.

The challenge, c, is an element of a challenge space, C. The challenge space C is a polynomial in R_{q} whose sized depends on the commitment, w. The definition in FIG. 7a therefore defines in formal terms that the challenge set is large enough (i.e. enough different challenge values are possible) such that the scheme is secure.

### Fourth Embodiment—Two-Round Signature Scheme

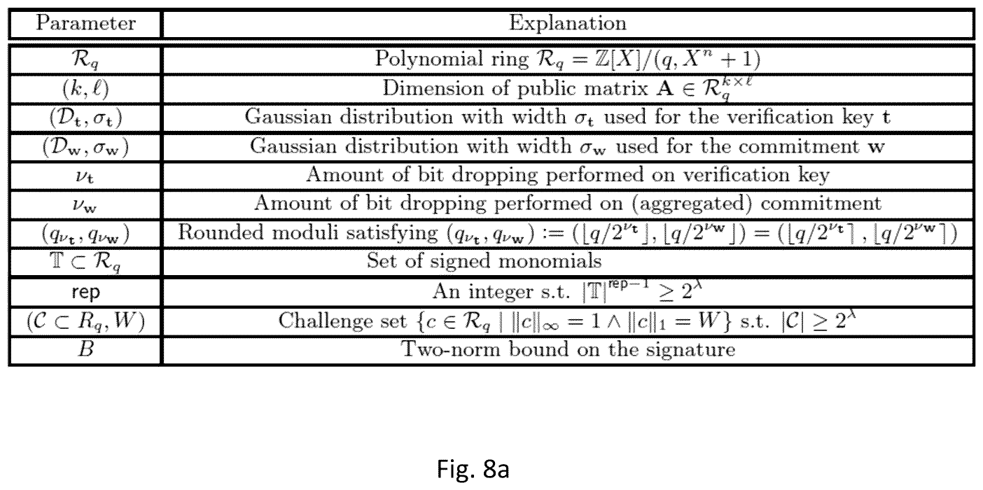

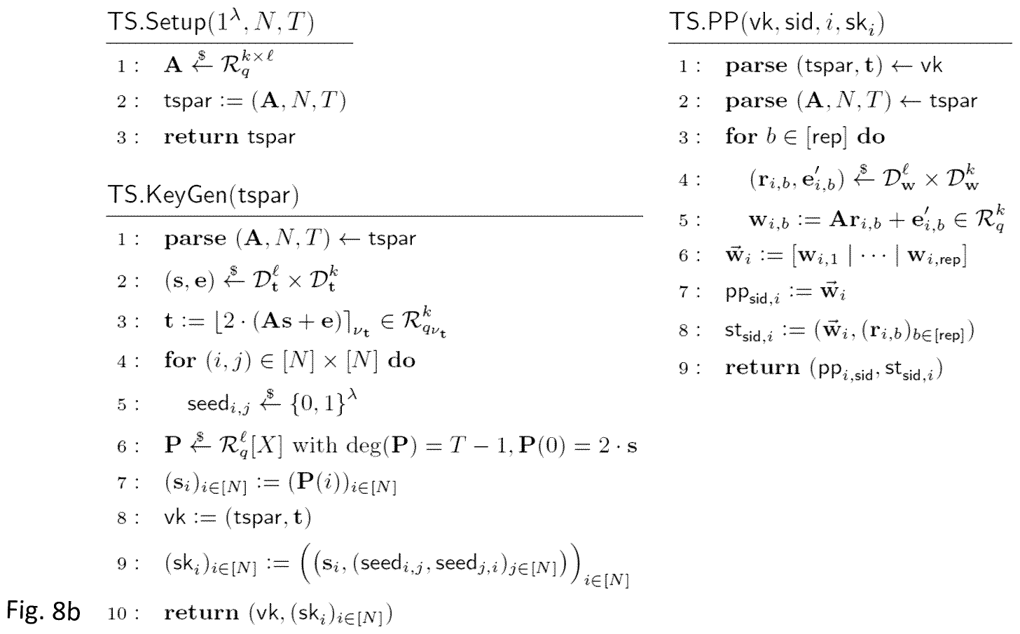

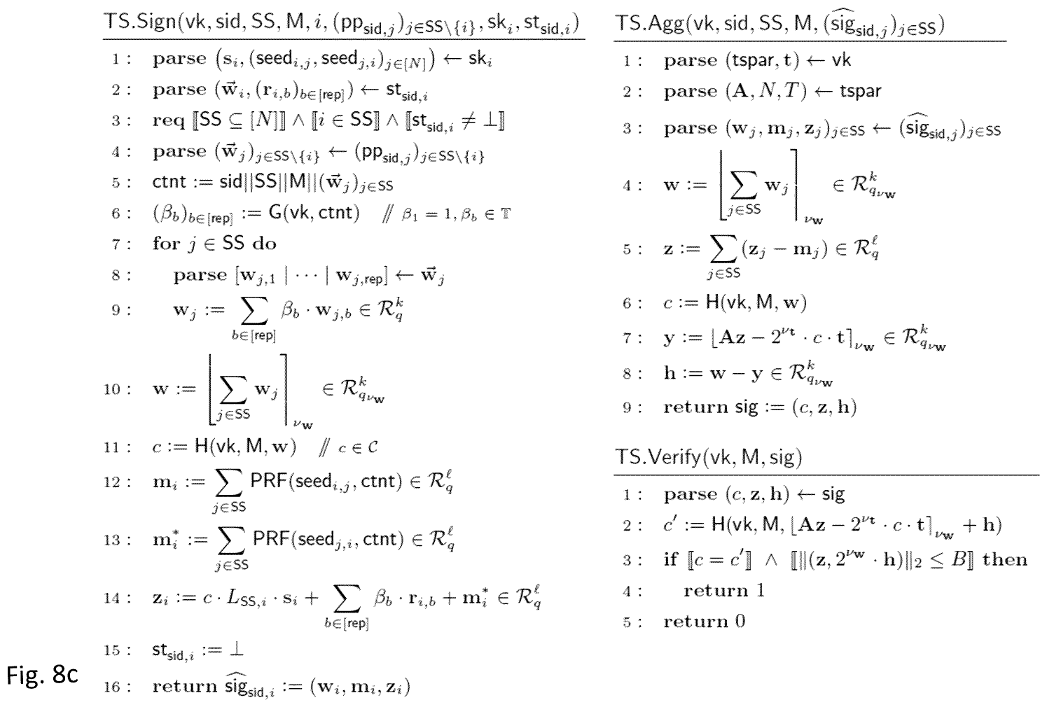

The first to third embodiments relate to three-round signature schemes. The fourth embodiment relates to a two-round signature scheme. As a general comment, steps ShareSign₁ and ShareSign₂ in the previous schemes relate to a commitment scheme in which LWE commitments, wᵢ, are shared. As will be described further below, FIGS. 8a to 8c illustrate a two-round threshold signature scheme in which the commitments take the form of a vector and can be generated in a pre-processing process before a single stage signature process.

FIG. 8a is a table that provides a glossary for terms used in FIGS. 8b and 8c. Explanations of the terms will be provided in the following description.

FIG. 8b is a figure illustrating three processes: a setup process (Setup), a key generation process (KeyGen), and a pre-processing process (PP).

The Setup process starts in step 1 by defining a polynomial Ring, A. The polynomial ring is of the same type as described in earlier embodiments. Other options will be described further below.

In step 2, parameters of the polynomial ring and the signature scheme are denoted tspar. The object tspar includes details of the polynomial ring A, the number N is a number of users, and the number T of signers required to complete a signature. In step 3, tspar is made available to all members of the signer group and the central actor.

In the key generation process, KeyGen, the parameters of tspar are parsed in step 1.

In step 2, the central actor generates a secret, s, from a distribution Dₜ. As noted in FIG. 8a, Dₜ is a Gaussian distribution over Rq. Accordingly, s is a sampled polynomial modulo q. Similarly, a small error, e, that is small relative to the lattice of the ring A such that t will be close to a polynomial in the polynomial Ring A.

In step 3, t is defined as the learning with errors (LWE) problem 2. (As+e). In the particular example shown, the LWE problem includes a multiple 2. However, in other implementations this term may be varied. The LWE problem is subject to bit dropping by an amount νₜ.

Steps 4 and 5 define seed generation in which binary seeds of length λ are generated for each combination of users in the signer group. This process is identical to seed generation described in connection with the earlier embodiments. As before, the seeds may be generated locally by each user or may be created by the central actor and distributed.

In steps 4, 6, and 7 Shamir secret sharing is performed to generate a secret share Si for each user of N users. The polynomial is of degree T−1 such that T secret shares are enough to reconstruct a polynomial P. The value of the polynomial P at 0 is equal to 2 times the secret, S.

In step 8, a public key, vk, is defined which is the parameters of the polynomial ring and signature scheme, tspar, and the LWE problem, t.

In step 9, a secret key, skᵢ, is defined for each user in the signer group. The secret key, skᵢ, is the secret share for the user and a set of seeds (both receiving seed_{i,j} and sending seed_{j,i}).

In step 10, the public key is made available. Each user receives a respective secret key, skᵢ. The secret keys are not made publicly available or available to other users in the signer group. Accordingly, each user only receives their secret share, sᵢ.

The preprocessing (PP) process is performed by at least each user in a signing set of T users. The steps of the PP process do not require use of the message to be signed, msg. Accordingly, the PP process may be performed as an offline process prior to signature in the Sign process.

In step 1 of the PP process, the user parses the public key, vk, to obtain tspar and the LWE problem, t.

In step 2, the user parses tspar to obtain the ring A, the number of users N and the threshold number of users T.

In steps 3 to 5, a number, rep, of commitment values indicated by index b are generated by each user. As indicated in FIG. 8a, rep is a number that is selected such that | [symbol] |^{rep-2}≥2^{λ}. It is recalled that λ is the seed length. The parameter λ is selected according to the number of bits of desired level of security. Accordingly, for 128 bit security, λ is set to 128.

[symbol] is a set of signed monomials, defined as (−1)^{b}.Xⁱ|(b, i)∈{0,1}×[n]. In a subsequent signing step, random weights β will be generated that are elements of the set of monomials. Accordingly, rep, is a number of individual commitments, w_{i,b}, that are generated and rep is selected to ensure a large enough range of possible random weights and hence to the security of the scheme.

In step 4, rep randomness, rib and associated errors, e′_{i,b} are sampled using a Gaussian distribution. In step 5, each user generates individual commitments w_{i,b}, which are a product of the randomness and the polynomial Ring, A, plus the error. The individual commitments, w_{i,b}, are concatenated into an individual commitment vector, [symbol] , in step 6. The individual commitment vector is set as a token pp_{sid,i}. The individual commitment vector and the rep generated randomness, r_{i,b}, form a state st_{sid}. The token and state are returned from the preprocessing process.

FIG. 8c shows steps of a signature process, Sign, an aggregation process, Agg, that may be performed by a central actor such as a server, and a signature verification process, Verify, performed by a party receiving the signature.

The Sign process is performed by each user in a signing set, SS, of at least T users. The user first parses the secret key, skᵢ, in step 1. In step 2, the user parses the state, st_{sid}.

Step 3 includes a series of checks and identifies that the Sign process is performed by users in a signing set, SS, that is a subset of the set of N user devices. The index i is used to indicate each user in the signing set, SS. The state is checked to ensure that each user in the signing set has performed the pre-processing method.

In step 4, the user device obtains the individual commitment vectors from the tokens from other users in the signing set.

In step 5, a commitment, ctnt, is generated that is a concatenation of the session id, the identity of users in the signing set, the message to be signed, M, and the individual commitment vectors of all users in the signing set.

In step 6 a series of rep random weights, Bb having index b, are generated using a random oracle, such as a Hash function, G. G, which maps, {0, 1}*→{1}× [symbol] ^{rep-1} is used to aggregate the individual commitments into one commitment. In the preprocessing process each user outputs rep commitments and G is used in steps 9 and 10 to aggregate them. The hash function G may be a hash function of the type that appears in Fiat-Shamir based signatures, such as CRYSTALS-Dilithium and Schnorr signatures. The hash function G takes the public key, vk, and the commitment, ctnt, as inputs.

Steps 9 and 10 aggregate the commitments. In step 9, the rep components of each individual commitment vector are summed together using the random weights generated in step 9 to generate an aggregated commitment per user, wⱼ. The aggregated commitments per user are then summed over the users in the signing set in step 10 to generate an overall commitment, w. The overall commitment, w, is subject to bit dropping by ν_{w} bits.

In step 11, a challenge, c, is generated using a hash function, H. The hash function H is different from hash function G. The hash functions may be derived from a single hash function using appropriate domain separation. The challenge is generated by taking a hash of the public key, vk, the message, M, and the overall commitment, w.

The challenge, c, is an element of a challenge set, C. The challenge set C consists of {−1,0,1} coefficient polynomials with a fixed Hamming weight W>0. The definition in FIG. 8a defines in formal terms that the challenge set is large enough (i.e. enough different challenge values are possible) such that the scheme is secure given a security parameter, λ.

In step 12, row blinders mi are generated for each user device, i, by summing across j. The sum is a sum of outputs of a pseudorandom function, PRF, that takes the seeds, seed_{i,j} generated in the key generation process and the generated commitment, ctnt, as inputs.

In step 13, column blinders m *; are generated for each user device, i, by summing across j. The sum is a sum of outputs of a pseudorandom function, PRF, that takes the seeds, seedj,i generated in the key generation process and the generated commitment, ctnt, as inputs.

As described above, a feature of the row and column blinders, as illustrated in FIG. 3, is that:

$${\sum }_{j ∈ act} {m}_{j , act} = {\sum }_{j ∈ act} {m}_{j , act}^{*}$$

As illustrated in FIG. 3 in connection with seeds used to generate the blinders, each blinder is generated as a sum of partial blinders over a row, for row blinders, mⱼ, and over a column for column blinders, m*ⱼ. As the sum of the row blinders is equal to the sum of all partial blinders in a grid and the sum of the column blinders is also the sum of all partial blinders in the grid, the equality above must hold. This allows the summed row and column blinders to be used to cancel each other out in the aggregation process described later.

In step 14, an individual response, zᵢ, is generated. The individual response if formed as a sum of three terms. The first term is a product of the challenge, c, a Lagrange coefficient, L_{ss,i}, associated with the device and the secret shared stored by the device, sᵢ. The second term is a sum over b of the random weights, β_{b}, and the randomness, r_{i,b}. The third term is the column blinder, m*.

In step 15, the state, st_{sid}, is set to null.

In step 16, an individual signature contribution, [symbol] , is returned by each user. The individual signature contribution comprises the overall commitment, w, the row blinder, mi, and the individual response, zi.

The aggregation process, Agg, shown in FIG. 8c is a combine operation performed by the central actor. In step 1, the central actor obtains the public key, vk=(tspar,t), generated in the key generation phase. Here it is noted that t=2. (As+e).

In step 2, tspar is parsed to retrieve the polynomial ring, A, the number of users, N, and the threshold number of users for signature, T.

At step 3, the individual signature contributions, [symbol] , are parsed to retrieve the overall commitment, w, the row blinder, mᵢ, and the individual response, zᵢ.

At step 4, the central actor generates a final commitment, w. The final commitment, w, is obtained by summing, across the signers, the overall commitments, wᵢ, included in the individual signature contributions. The final commitment is subjected to bit dropping in accordance with a parameter, ν_{w}, which is a parameter that is made openly available to signers using the signature method.

At step 5, the central actor generates an aggregated response, z, by summing differences of the individual responses, zᵢ, less the row blinders, mⱼ. As noted, the row blinders cancel the column blinders included in the individual responses to hide information.

At step 6, the central actor generates a global challenge, c. The global challenge, c, is generated by hashing the public key, vk, the message to be signed, M, and the total commitment, w, calculated in step 4. The central actor generates the hash using a function H. The Hash function may, in some examples, be selected from the four recommended hash functions in NIST special publication 800-185: SHA-3 Derived Functions: cSHAKE, KMAC, TupleHash and Parallel Hash. In a further example, SHAKE described in NIST publication FIPS PUB 202: SHA-3 Standard: Permutation-Based Hash and Extendable-Output Functions may be used. The Hash functions used in the fourth embodiment should preferably be different, at least in the parameters used. The selection of different hash functions has the effect of domain separation and may improve the security of the signature scheme.

In step 7, a noisy commitment, y, is generated by the central actor. The noisy commitment is generated from the difference of two components. The first component is a product of the polynomial ring, A, and the aggregated response, z. The second component is a product of the global challenge c, calculated in step 5, and t=2.(As+e) generated in the key generation phase. The calculated difference is subjected to bit shifting to multiply the value by two to the power νₜ. This is a renormalization to allow for bit dropping. The noisy commitment is then subject to bit dropping by ν_{w} bits. Both νₜ and ν_{w} are public parameters.

At step 8, a hint, h, is generated by the central actor. The hint is a difference between the total commitment, w, and the noisy commitment, y.

At step 9, the signature of the message, M, is provided. The signature includes three components: the global challenge, c, the aggregated response, z, and the hint, h.

Public parameters vi and ow are referred to above and may be generated as described in connection with the first embodiment.

As the signature generated by the fourth embodiment is the same as that generated in previous embodiments, the verify process shown in FIG. 8c is the same as that previously described in connection with FIG. 5. The description of FIG. 5 is accordingly not repeated.

The embodiment above uses a session id, sid. In a further embodiment, the session id may not be included. With the exception of forming an index to label parameters in FIGS. 8a to 8c, the session identifier appears in step 5 of the Sign process. In step 5, the commitment, ctnt, may be generated as a concatenation of the identity of users in the signing set, the message to be signed, M, and the individual commitment vectors of all users in the signing set. Further, the step of parsing the state (step 2 in the Sign process illustrated in FIG. 8c) may be omitted. The information from the preprocessing, PP, process may be conveyed in the token, PP.

### Fifth Embodiment-Threshold Decryption Scheme

The first to the fourth embodiments have related to a threshold signature scheme. In contrast, the fifth embodiment relates to a threshold decryption scheme.

A threshold decryption scheme requires that a message can only be decrypted if T-out-of-N authorities agree to decrypt.

According to the method described below, a decryption algorithm first performs the correctness check and only then performs decryption if the check is passed. This approach requires encrypting party to generate a proof that their ciphertext is correct. Anyone, including people who do not know the secret key, can perform the correctness check. Accordingly, this step is easy to adapt for a threshold number of decrypting parties than prior techniques.

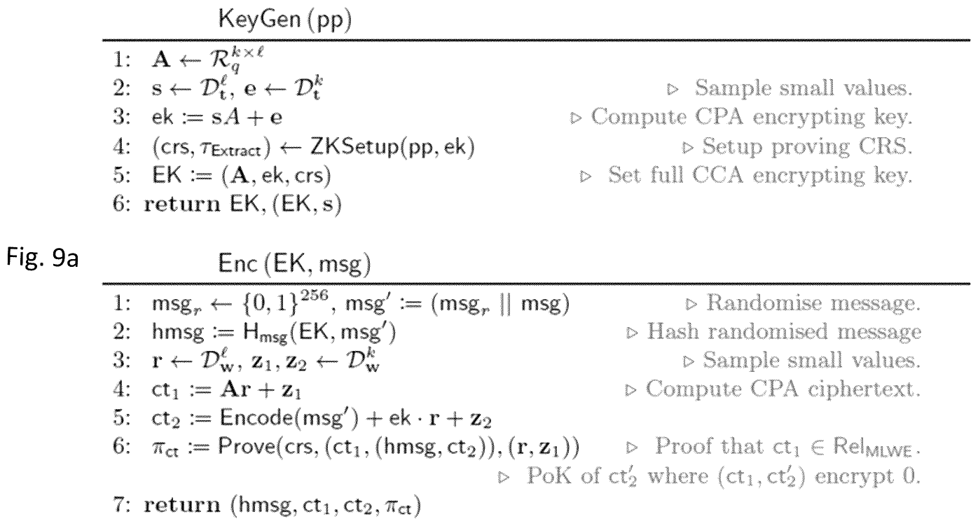

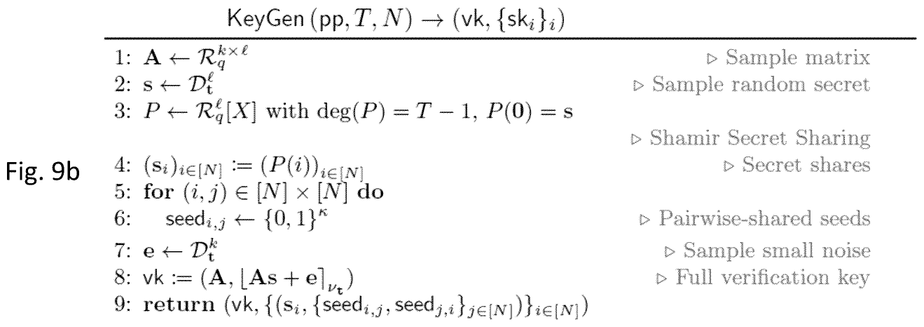

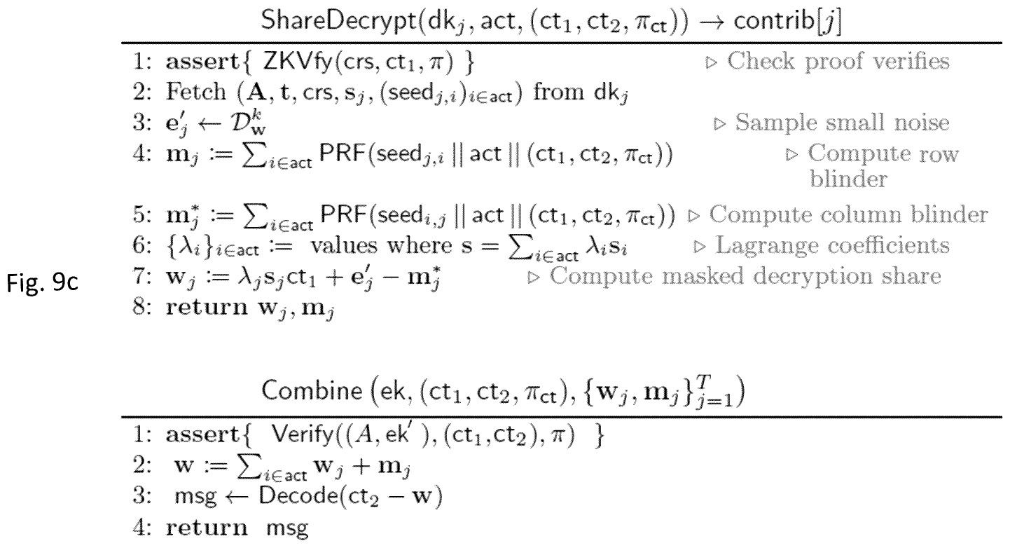

FIG. 9a shows a key generation process, KeyGen, for generating an encryption key and an encryption process, Enc, for encrypting a message, msg, using the encryption key. The key generation process will be described first.

In step 1 of the key generation process, a central actor or user defines a polynomial Ring, A. The polynomial ring is of the same type as described above. Other options will be described further below.

In step 2, the key generation algorithm samples short secrets (s, e)←D^{k}ₜ×D^{k}ₜ. An encryption key, ek, is an LWE sample, As+e, with respect to polynomial ring, A, as shown in step 3.

In step 4, a setup for a Zero Knowledge Proof system is run with respect to encryption key, ek. The Zero Knowledge Proof system contains three functions, Setup, Prove, and Verify as will be described in more detail below. The setup is (crs, τ_{Extract})←ZKSetup (pp, ek), to generate a common reference string, crs, and an extractor trapdoor, τ_{Extract}. The extractor trapdoor is disposed of an is not used in the remainder of the method.

In step 5, the full encryption key, EK, is defined consisting of polynomial ring, A, encryption key, ek, and the common reference string, crs. The decryption key, dk, is simply s. The generated full encryption key, EK, and secret, s, are returned in step 6.

In the lower part of FIG. 9a, the encryption process, Enc is illustrated.

In a first step of the encryption process, a message randomness, msgᵣ is generated that is a random 256-bit binary string. The message randomness is concatenated with a message to be encrypted, msg, to generate an extended message, msg′.

In step 2, the encryption key, EK, and the extended message, msg′, are hashed using a hash function, H_{msg}.

In step 3, an ephemeral randomness, r, is sampled which is a polynomial from the polynomial ring, A. Two small error terms, z₁ and z₂, are sampled using a Gaussian distribution.

In step 4, the encryption process calculates a first ciphertext component, ct₁, where ct₁:=Ar+z₁.

In step 5, a second ciphertext component, ct₂, is calculated, where ct₂: =Encode(msg′)+ek·r+z₂. The encryption being used here is Regev encryption, which is a form of Decisional LWE. A receiver of a message needs to decide whether received values have been calculated as Ar+z (i.e. as polynomials close to polynomials in the ring) or not in order to recover 1 or 0 bits. Accordingly, Encode (msg′) encodes the extended message bit-wise generating polynomials to encode the bits. Regev encryption is a well-known encoding scheme, so the details of Encode are not provided here.

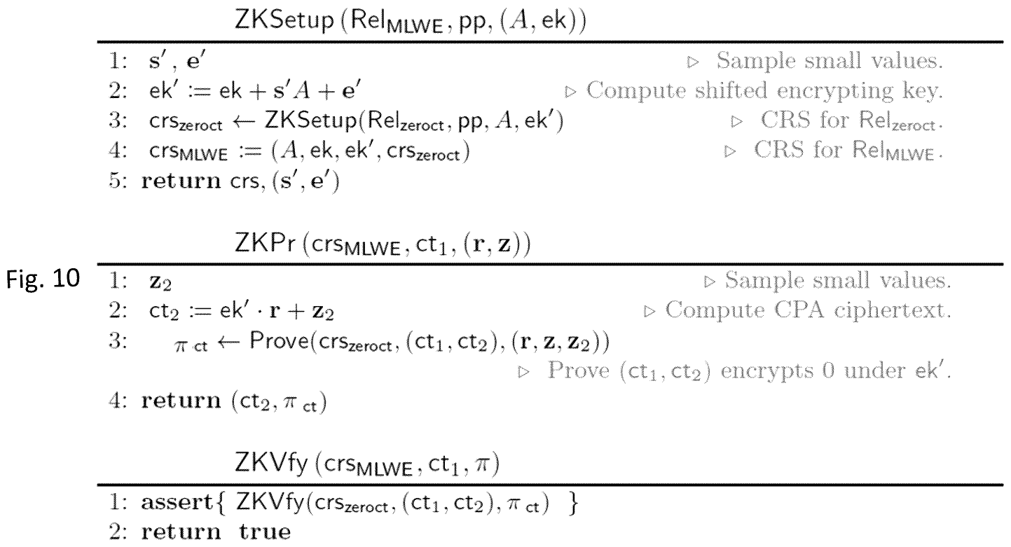

Step 6 provides a Zero-knowledge proof that the ciphertext contains an LWE instance. The Zero Knowledge Proof ensures that, in the threshold setting, an adversarial ciphertext cannot cause the decryption transcripts to leak sensitive information. The Zero Knowledge proof proves that ct₁ is well formed and that the signer can generate an encryption using ct₁ of a plaintext 0 message. Step 6 generates a zero-ciphertext extractable zero-knowledge proof π_{ct} such that (ct₁, aux)∈Rel_{MLWE}, where aux=(hmsg, ct₂) and Rel_{MLWE} is a relationship described below. hmsg was defined in step 2. The function ‘Prove’ is from the Zero Knowledge Proof system mentioned above, which will now be described. The Zero Knowledge Proof System comprises three functions: setup, prove and verify. These functions are illustrated in FIG. 10 and operate as follows:

### Setup (ZKSetup):

The setup algorithm shown in FIG. 10 takes as input the system parameters together with a CPA public key (A, ek). In step 1 it samples small values s′ and e′. In step 2 a shifted encryption key ek′=ek+As′+e′ is generated. Next, in step 3, it runs a setup for a relationship, Rel_{zeroct}, with respect to the shifted encryption key ek′. The ZKSetup, Prove and ZKVfy functions are Zero Knowledge proof functions. In one example, the functions implement the ‘commit and prove’ system described in ‘Lattice-based zero-knowledge proofs under a few dozen kilobytes’ by NK Nguyen, 2022 (see for example FIG. 6.3 of that paper). The common reference string, crs, is a set of public parameters that are used to generate the zero-knowledge proof and to verify the proof.

In steps 4 and 5, the setup process returns the MLWE common reference string as crs_{MLWE}=(A, ek, ek′, crs_{zeroct}) and an extraction trapdoor τ_{Extract}=(s′, e′). As noted above, the extraction trapdoor is discarded.

### Prove:

The prove process takes as input the MLWE common reference string crs_{MLWE}, the CPA ciphertext, ct₁, generated during the encryption step and a witness (r, z₁).

In step 1, a small random value Z2 is sampled.

In step 2, a CPA ciphertext of a message 0 under the shifted public key, ek′, is calculated.

In step 3, a proof π_{ct} is generated. The proof proves that the signer can sign zero ciphertext, ct₂, generated in the preceding step, under the first component, ct₁, from the encryption shown in FIG. 9a. The ‘Prove’ function takes the crs_{zeroct} (i.e. the previously generated public parameters for performing the ZKP), the first component, ct₁ (which is an LWE sample) and generates a proof π_{ct}. As with the Setup function, the Prove function implements the technique set out in ‘Lattice-based zero-knowledge proofs under a few dozen kilobytes’ by NK Nguyen 2022.

In step 4 the proof, π_{ct}, and the CPA ciphertext of message 0, ct₂, are output.

### Verify:

The verification algorithm takes as input the MLWE common reference string, CISMLWE, the first component, ct₁, the CPA ciphertext of a message 0, ct₂, and the proof π_{ct}. It returns true if and only if (ct₁, ct₂), π_{ct} verifies. That is to say that (ct₁, ct₂) encrypts 0 under ek′. The relations being proved are:

$${Rel}_{Zeroct} = \{ instance = ( {ct}_{1} , {ct}_{2} ) , witness = ( r , {Z}_{1} , {Z}_{2} ) \vert \begin{matrix}{ct}_{1} = Ar + {Z}_{1} \\ {ct}_{2} = {ek}^{′} \cdot r + {Z}_{2} \\ r ∈ {D}_{MLWE}^{l} \\ {Z}_{1} ∈ {D}_{MLWE}^{k} \\ {Z}_{2} ∈ {D}_{MLWE}^{k}\end{matrix} \}$$

$${Rel}_{MLWE} = \{ instance = ( w , aux ) , witness = ( r , {e}^{′} ) \vert \begin{matrix}w = Ar + {e}^{′} \\ r ∈ {D}_{MLWE}^{l} \\ {e}^{′} ∈ {D}_{MLWE}^{k}\end{matrix} \}$$

where w=Ar+e′ is the LWE sample on a polynomial ring A, where aux=(hmsg, ct₂) and ct₂ is the second component of the ciphertext.

When (ct₁, aux)∈Rel_{MLWE}, the decryption that cannot reveal any useful information about the secret key to an adversary.

Returning to the encryption function, Enc, at the bottom of FIG. 9a, in step 7, the full ciphertext is returned which consists of (hmsg, ct₁, ct₂, π_{ct}).

An algorithm for key generation for threshold decryption, KeyGen, is shown in FIG. 9b. Some steps are duplicated with the key generation previously described in connection with KeyGen shown for encryption in FIG. 9a. In practice these steps aren't duplicated. Steps 1 and 2 are such duplicate steps and correspond to the creation of the polynomial ring, A, and sampling a secret, s, described in steps 1 and 2 of KeyGen described for the encryption side. In steps 3 and 4, the secret s is used to generate Shamir secret shares, sᵢ, from a polynomial of degree T−1, where evaluation of the polynomial at zero reveals the secret, s. The secret shares correspond to evaluations of the polynomial P at locations other than 0.

In steps 5 and 6, pairwise shared seeds are generated using the same way as described previously in connection with the previous embodiments.

In step 7 a small noise, e, is sampled.

In step 8 a public key, vk, is returned including the ring, A, and an LWE sample, Aste. The LWE sample is subject to bit dropping of νₜ bits.

In step 9, the key generation algorithm returns the public key, which is made publicly available. Each user is provided with a respective secret share, sᵢ, and a corresponding set of seeds.

FIG. 9c shows a process, ShareDecrypt, performed by each of a threshold T number of users to generate a decryption share for the decryption process. At the lower part of FIG. 9c, a combine method is shown to combine the decryption shares to decrypt the message.

In step 1 of the ShareDecrypt process, the verify function of the Zero Knowledge Proof is performed. This has been described above in connection with FIG. 10. As noted above, this proves that the signer was able to use the first ciphertext component, ct₁, in order to encrypt a second component containing a zero message.

In step 2, various parameters are obtained from a decryption key share, dkⱼ. As indicated, the decryption key share includes the polynomial ring, A, t (where t=As+e that forms part of the previously generated public key, vk), the common reference string, crs (which is crs_{MLWE}), the secret share, sⱼ, and the seeds generated in the key generation process.

In step 3, a small noise, eⱼ′ is sampled.

In step 4, a row blinder, mⱼ, is generated by summing the output of a pseudorandom function, PRF, that takes the following inputs: the row seeds as explained with reference to the earlier embodiments, identity of the party performing ShareDecrypt, the first ciphertext component, ct₁, the second ciphertext component, ct₂, and the proof, π_{ct}.

In step 5, a column blinder, m*ⱼ, is generated by summing the output of a pseudorandom function, PRF, that takes the following inputs: the column of seeds as explained with reference to the earlier embodiments, identity of the party performing ShareDecrypt, the first ciphertext component, ct₁, the second ciphertext component, ct₂, and the proof, π_{ct}

Step 6 defines the Lagrange coefficients from the Shamir secret sharing scheme. As indicated, the sum of the product of the secret shares and the Lagrange coefficients allows recovery of the original secret. This relationship is described above and is known in the art in connection with Shamir Secret sharing scheme.

In step 7, masked decryption shares, wⱼ, are generated. The masked decryption shares are formed as a product of the Lagrange coefficient, the secret share and the first ciphertext component plus the small noise minus the column blinder. The small noise and the column blinder serve to mask the product of the Lagrange coefficient, the secret share and the first ciphertext component. The product of the Lagrange coefficient, the secret share and the first ciphertext component enable the combine process to decrypt the ciphertext.

In step 8, each of the threshold T users returns their masked contribution share, wⱼ and the row blinder, mⱼ.

The bottom portion of FIG. 9c, shows a Combine process, which is performed by a central actor to combine the contributions from a threshold number, T, of users who have performed the ShareDecrypt process.

In step 1, the central actor performs the Verify process described above in connection with FIG. 10 to verify the Zero Knowledge Proof. As noted above, this proves that the signer used the first ciphertext component, ct₁, in order to encrypt a second component containing a zero message.

In step 2, a product of the masked decryption shares, wⱼ, and the row blinders, mⱼ, are summed across the threshold number of users. Here it is noted that:

$$w := {\sum }_{i ∈ act} {w}_{j} + {m}_{j} := {\sum }_{i ∈ act} {λ}_{j} {s}_{j} {ct}_{1} + {e}_{j}^{′} - {m}_{j}^{*} + {m}_{j} := s {ct}_{1} + {e}^{′}$$

In step 3, the process decodes ct₂−w. This can be expanded as follows:

$${ct}_{2} - w := Encode ( {msg}^{′} ) + ek \cdot r + {z}_{2} - s ( Ar + {z}_{1} ) + {e}^{′}$$

$$:= Encode ( {msg}^{′} ) + ( SA + e ) \cdot r + {z}_{2} - s ( Ar + {z}_{1} ) + {e}^{′}$$

$$:= Encode ( {msg}^{′} ) + {z}_{2} - {sz}_{1} + d$$

Here d is a small distribution that includes the e.r and e′ terms.

Now including the Decode:

$$m s {g}^{′} = Decode ( Encode ( {msg}^{′} ) + {z}_{2} - s {z}_{1} + d )$$

because z₂, s, z₁, d are chosen from sufficiently small distributions the extended message, msg' can be recovered. The extended message msg′ can be separated into msgᵣ=msg′[: 256] (i.e. the first 256 bits) and msg=msg′[256: ] (i.e. the second 256 bits). Here msg is the plaintext and msgᵣ is a proof of correct decryption. The Combine process returns both (msg, msg). The Combine process may check whether or not msg′ verifies against hmsg included in the ciphertext and leaves the verification of the plaintext to external algorithms which implement Regev decryption corresponding to the Encode described above. As noted above, this is done by use of decisional LWE.

### Sixth Embodiment—Threshold Decryption Scheme Variant

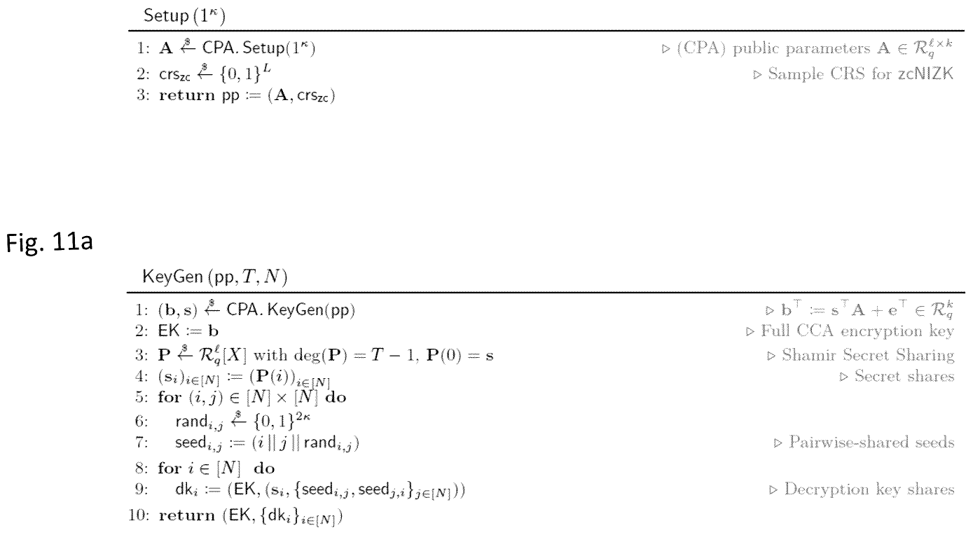

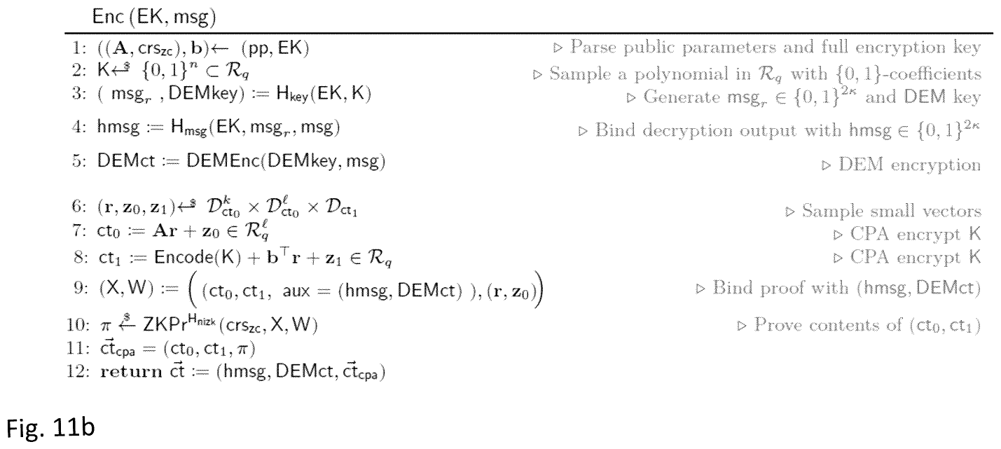

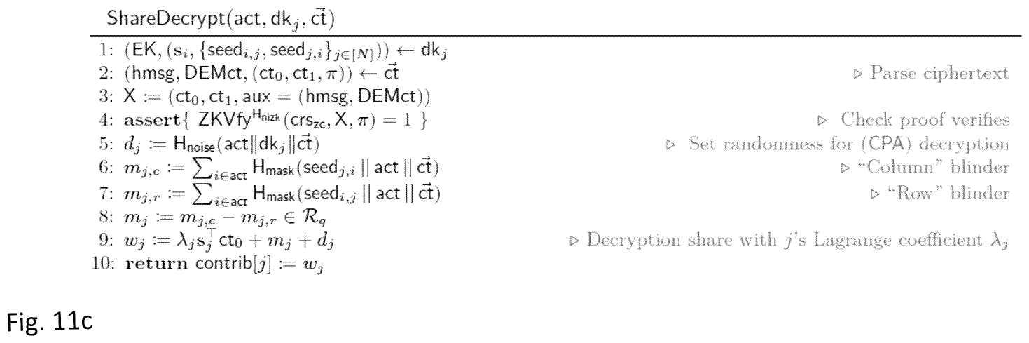

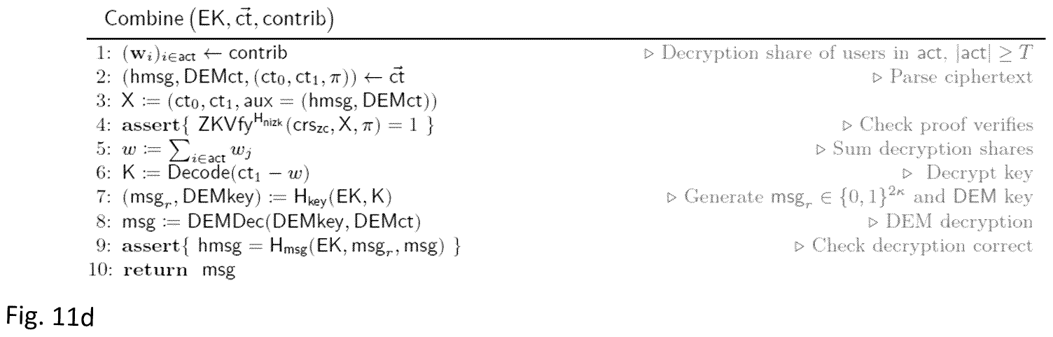

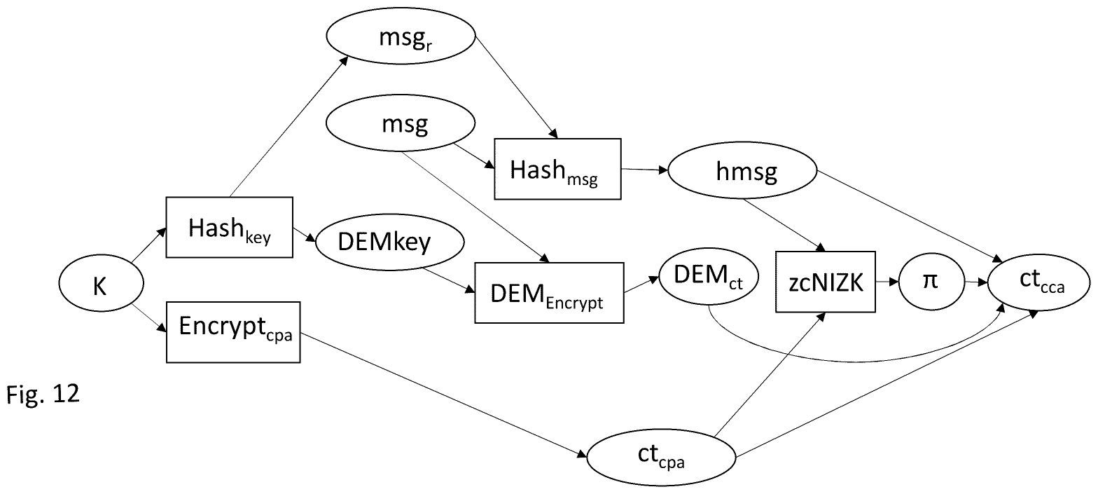

A threshold decryption method similar to the method described in the fifth embodiment will now be described with reference to FIGS. 11a to 11d and FIG. 12.

The following method makes use of a Key Encapsulation Mechanism (KEM), such as CRYSTAL-KYBER. The KEM consists of four functions as follows:

Setup (1^{k})→pp: a setup algorithm takes a security parameter k as input and outputs a public parameter pp. In FIGS. 11a to 11d, it is assumed that pp is provided and the step of generating pp is not illustrated.

KeyGen (pp)→(ek, dk): a key generation algorithm takes a public parameter pp as input and outputs a pair of keys (ek, dk).

Encap (ek)→(K, ct): an encapsulation algorithm takes an encapsulation key ek as input and outputs a shared key, K and a ciphertext ct that encrypts the shared key, K.

Decap (dk, ct)→K: a decapsulation algorithm takes a decapsulation key dk and a ciphertext ct as input and outputs the shared key K.

The method further makes use of an IND-CPA secure KEM, such as that proposed by Lindner and Peikert (Better Key Sizes (and Attacks) for LWE-Based Encryption′—Topics in Cryptology-CT-RSA 2011) or Lyubashevsky, Peikert and Regev (‘A Toolkit for Ring-LWE Cryptography’—Advances in Cryptology-EUROCRYPT 2013). The IND-CPA secure KEM includes two algorithms: Encode and Decode. Encode: {0, 1}ⁿ→R_{q} is a function that maps

$$K ∈ {\{ 0 , 1 \}}^{n} ⊂ Rq to \frac{⌊ q}{2 ⌉} . K ,$$

where we consider K as a polynomial in Rq= [symbol] [X]/(Xⁿ+1) with {0, 1}-coefficients. Moreover, Decode→: Rq {0, 1}ⁿ is a function that maps each coefficient w∈R_{q} to 0 (respectively 1) if it is close to 0 (respectively

$$\frac{⌊ q}{2 ⌉} )$$

in absolute value. This is a form of the decisional LWE referred to in the fifth embodiment.

FIG. 11a shows sets of a setup procedure and a KeyGen procedure. These two procedures formed part of a single KeyGen procedure in FIG. 9a.

In a first step of the Setup procedure, a central actor or user defines a polynomial Ring, A. The polynomial ring is of the same type as described above. Other options will be described further below.

In the second step, a common reference string, crs_{zc} is sampled which is a binary string of length L. The method returns the ring, A, and the common reference string, crs_{zc}, as public parameters. The number of users and the threshold number required for decryption are also defined at this stage.

The KeyGen procedure starts at step 1 with use of the KeyGen algorithm from the KEM to generate a public key, b, and a secret key, s. In step 2, the public key, b, is set as the full encryption key EK. As before, the public key, b, is a sum of the product of the secret key, s, and the public matrix, A, and an error, e.

In steps 3 and 4, the secret key s is shared between all users in a threshold-friendly manner. To achieve (T, N)-threshold decryption, the secret is split using the Shamir Secret Sharing as the evaluations of a polynomial of degree T−1 over the set [N]. This involves sampling a polynomial P of degree T−1 that evaluates to s at P (0). The secret shares are evaluations of P at N different values, i.

Steps 6 and 7 describe generating seeds, seed_{i,j}. Random values are generated as an N×N grid of random values by repeatedly sampling a random string. The seeds are generated from each random value in the grid, which is concatenated with associated values i and j from the row and column axes such that there is a pairwise seed for each of the N potential signers in the threshold signature scheme.

In step 9, decryption key shares for each potential signer, i, are formed that include the full encryption key, EK, and a set of seeds for a column and row of the grid associated with potential signer, i.

Referring now to FIG. 11b an encryption procedure will be described that generates a ciphertext. This method is performed by a party prior to the threshold decryption that will be described subsequently. The encryption is not thresholdized and can be run by any party with the public key. It is only the decryption key which is secret shared. The encryption procedure encrypts a message, msg.

In step 1, the public matrix A and the public secret b are obtained that were generated in the setup procedure. In step 2, the encryptor chooses a random key K that is a binary string.

In step 3, the random key, K, is hashed with the full encryption key, EK, to product a message randomiser, msgᵣ, and a DEM key, DEMkey.

In step 4, the encryptor computes a hash, hmsg=Hmsg(EK, msgᵣ, msg). This will later be used by the combine algorithm to guarantee that the combiner either produces an error or the correct message.

In step 5, the message, msg, is encrypted under DEMkey using the encapsulation function of the KEM to generate a symmetric ciphertext, DEMct, using a symmetric encryption scheme such as AES.

In steps 6 to 8, the encryptor encrypts random key, K, under the encryption key EK. In step 6, small vectors r, z₀ and z₁ are sampled from a distribution. In step 8, the Encode function is from the IND-CPA secure KEM described above and encodes the random key using decisional LWE. Accordingly, in step 7, a first ciphertext value, ct₀ is calculated as a sum of the small vector, z₀, and a product of the public matrix, A, and small vector, r. A second ciphertext value, ct₁, is calculated in step 8 as a sum of the encoded random key, K, a product of the public key, b, and small vector, r, and the small vector, z₁.

In steps 9 and 10, the encryptor proves correctness of (ct₀, ct₁) using a zero-ciphertext extractable proof. In general, a Non-Interactive Zero Knowledge (NIZK) proof has two algorithms ZKPr and ZK Vfy.

ZKPr (crs, X, W)→π: The prover algorithm takes as inputs the common random string crs∈{0, 1}^{L}, statement and witness pair (X,W)␣R, and outputs a proof π.

ZKVfyH(crs, X, π)→b: The verifier algorithm takes as inputs the crs, a statement X and a proof π, and outputs a bit b either 1 (accept) or 0 (reject).

In more detail, the method shown in FIG. 11b includes a proof of statement X:

$$X = ( ct 0 , ct 1 , aux = ( hmsg , DEMct ) )$$

The witness, W, is (r, z₀).

In steps 11 and 12 a ciphertext \vec{ct} is generated based on ct0, ct1, the proof, π, the hash, hmsg, and the symmetric ciphertext, DEMct.

FIG. 12 shows the different steps that make up the ciphertext, \vec{ct}, referred to as ct_{cca} in FIG. 12 providing a convenient overview of the method just described.

FIG. 11c shows steps of a ShareDecrypt procedure performed by each of at least at a threshold number T of users to decrypt the message. By separately performing this method the users aim to jointly compute w=s·ct₀+d where d is a small secret error chosen to mask the leakage from s·ct₀.

In steps 1 and 2 of the ShareDecrypt procedure the information in the decryption key share, dkⱼ, of each user is parsed and the ciphertext to be decrypted is parsed. In step 3, the statement X is retrieved.

In step 4, the statement X is verified using the function ZKVfy based on the statement X, the proof, π, the common reference string, crs_{zc}. If the proof does not verify, the method aborts. Otherwise, if the proof is verified, the method proceeds to step 5. This step prevents man-in-the middle attacks.

In step 5, a share of a randomness d, dⱼ, is generated by taking a hash of an identity of the group of users, the decryption key share, dkⱼ, and the ciphertext, \vec{ct}.

To compute the s ct₀ component in step 9, the users will each compute λᵢ·sᵢ·ct₀ where {λi}ᵢ∈_{act} are the Lagrange coefficients such that:

$$s = {\sum }_{i ∈ act} {λ}_{i} {s}_{i}$$

However, the users cannot reveal λᵢ·sᵢ·ct₀ in the clear without leaking their decryption key shares. Instead, in step 8, each party j computes blinders mⱼ∈Rq such that Σ_{j∈at}mⱼ=0. More precisely, in steps 6 and 7, they set the blinders as mⱼ=m_{j,c}−m_{j,r} for:

$${m}_{j , c} = {\sum }_{i ∈ act} {H}_{mask} ( {seed}_{j , i} ‖ act ‖ \vec{ct} )$$

$${m}_{j , r} = {\sum }_{i ∈ act} {H}_{mask} ( {seed}_{i , j} ‖ act ‖ \vec{ct} )$$

which appear random provided at least one of the seeds, seed_{j,i}, is unknown to the adversary. These are the row and column seeds that were described above in connection with the Setup procedure.

Accordingly in step 9, each user calculates a decryption share wⱼ that is a sum of λᵢ·sᵢ·ct₀, the blinder, mⱼ, and the share of a randomness, dⱼ. At the end of the ShareDecrypt procedure the decryption shares, wⱼ, are broadcast or otherwise published for use in the Combine procedure shown in FIG. 11d.

The Combine procedure shown in FIG. 11d allows a central actor or other party in possession of at least a threshold number T of the decryption shares to decrypt the ciphertext, \vec{ct}. In step 1, at least T decryption shares, wᵢ, are obtained following the ShareDecrypt procedure. In step 2, the ciphertext, \vec{ct}, is parsed and in step 3, the statement X is retrieved.

In step 4, the statement X is verified using the function ZKVfy based on the statement X, the proof, π, the common reference string, crs_{zc}. If the proof does not verify, the method aborts. Otherwise, if the proof is verified, the method proceeds to step 5. As with step 4 in the ShareDecrypt procedure, this step prevents man-in-the middle attacks.

In step 5, the decryption shares, wⱼ, are summed to obtain an overall decryption share. It is noted that in this step, the blinders mⱼ cancel to zero during the sum. Accordingly, the algorithm recovers s·ct₀+d.

In step 6, K is determined by using the decode algorithm from the IND-CPA secure KEM applied to ct₁−w. As d, z₀ and z₁ are small s·ct₀ is approximately equal to b·r. Accordingly, the decode function is applied to values similar to those that would be obtained using the encode function on K (see step 8 of FIG. 11b).

In step 7, the message randomizer and symmetric ciphertext, DEMct, are obtained using the random key, K, obtained in step 6 and the full encryption key, EK.

In step 8, the message, msg, is recovered using the decapsulation algorithm of the KEM and the DEMkey obtained in step 7.

In step 9, the decrypted message, msg, is checked against the hash, hmsg, using the message, msg, message randomizer, msgᵣ, and full encryption key, EK. This assertion ensures that msg is the correct plaintext and that malicious decryption shares cannot change the message.

Finally in step 10, the Combine procedure returns the decrypted message.

### Further Embodiments

The above embodiments have been described over a polynomial ring

$$A ϵ {ℤ}_{q}^{n \times m} .$$

However, the techniques described above are also applicable to Ring LWE where

$$A ϵ {R}_{q}^{l}$$

or to Module LWE over a module where

$$A ϵ {R}_{q}^{k \times l} .$$

In the embodiments above, the row and column blinders are generated using seeds and pseudorandom functions, PRF. In further embodiments, the partial blinders could be generated directly. For example, N blinders could be generated in connection with each secret share and the blinders could be distributed to respective other secret shares as described above as a step in each session. Accordingly, the use of seeds and a generator function, such as the PRF, is not necessary.

In connection with the sixth embodiment a single blinder was obtained as the difference between the column and row blinders. The resulting blinders sum to zero as noted in that embodiment. The same technique may be applied to the other embodiments removing the need to transmit the other of the row and column blinder for use in the combine or aggregation procedure. For example, in FIG. 6b at step 8 of ShareSign₃ the individual response, zⱼ, may be generated by replacing the column blinder, mⱼ, with a difference between the row and column blinders. In step 4 of the Combine procedure the aggregated response, z, is then generated by summing the individual responses and it is not necessary to subtract the row blinder. The same principle may be applied to step 13 of ShareSign₃ and step 4 of Combine shown in FIG. 7d. Further, the same principle may be applied to step 14 of TS. Sign and step 5 of TS.Agg shown in FIG. 8c.

As the row and column blinders are generated as a grid of random values, it does not matter whether the difference between the row and column blinder is taken or the difference between the column and row blinder is taken as the blinder value.

The setup steps in the above-described methods, such as key generation, may be performed fewer times than the signature or decryption steps. Accordingly, once public parameters have been generated, seeds generated and distributed etc. according to the above-described embodiments, multiple messages may be signed or multiple messages encrypted and threshold decrypted.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method performed by one or more information processing apparatus for calculating a linear function that includes a product of a secret, s, and a linear function component using a threshold number, T, out of a number N of secret shares generated from a secret, s, wherein the number of secret shares, N, is greater than the threshold number, T, the method comprising:
generating a public matrix, A, and the secret, s;
generating a small noise, e, and a public key, ek, that includes a sum of the small noise, e, with a product of the public matrix, A, and the secret, s;
generating N secret shares, sᵢ, from the secret, s;
for each of a threshold number, T, of the secret shares:
generating a blinder; and
generating masked shares of the calculation of the linear function by calculating
a first component that is based on a product of the secret share, and the linear function component, and adding or subtracting from the first component a noise and the blinder; and
in an aggregating phase:
summing a combination of the masked share associated with each secret share, whereby the blinders cancel out over the sum of masked shares to allow determination of the linear function.

2. A method according to claim 1, wherein the linear function is at least part of one of: a signature function and a decryption function.

3. A method according to claim 1, wherein generating the blinder comprises generating a first and a second blinder by, for each of T secret shares being used to calculate the linear function:
generating one of the first blinder and the second blinder as a sum of a first set of T partial blinders, the first set of partial blinders being formed of a partial blinder generated in respect of a secret share for the secret share itself and T−1 partial blinders generated in respect of the secret share for respective ones of the T−1 other secret shares;
generating as the other of the first blinder and the second blinder a sum of partial blinders in a second set of partial blinders, the second set being formed of T partial blinders for the secret share including the partial blinder formed in respect of the secret share for the secret share.

4. A method according to claim 3, wherein each partial blinder is generated using a generator function, and the generator function takes a seed as an input and the method comprises for each of N secret shares:
1) generating N seeds including a seed in respect of the secret share and a seed for each of the respective other N−1 secret shares; and
2) distributing the N−1 seeds for other secret shares to the respective other secret shares so that each other secret share receives a single seed, wherein following completion of the two steps for all of the N secret shares, each secret share is associated with 2N−1 seeds including N seeds that were generated in respect of that secret share and N−1 seeds that have been received during the distributions and were generated for the secret share.

5. A threshold signature method performed by one or more information processing apparatus for generating a signature using a threshold number, T, out of a number N of secret shares generated from a secret, s, wherein the number of secret shares, N, is greater than the threshold number, T, the method comprising:
generating a public matrix, A, and the secret, s;
generating a small noise, e, and a public key, vk=(A, t) including a portion of the public key, t, that comprises a sum of the small noise, e, with a product of the public matrix, A, and the secret, s; and
generating N secret shares, sᵢ, from the secret, s;
for each of the threshold number T of secret shares:
generating T individual commitments, wᵢ, each comprising one or more learning with errors samples, wⱼ;
aggregating the T individual commitments, wᵢ, to generate an aggregated commitment, w;
generating a challenge, c, that is a hash of at least a message to be signed, msg, and the aggregated commitment, w;
generating T individual responses, zⱼ, based on the challenge, c, the secret share, sⱼ, and one or more ephemeral randomness used to generate the one or more learning with errors sample, rⱼ;
in an aggregating phase:
generating the aggregated commitment, w, by summing the learning with errors samples, wⱼ across the T secret shares;
generating an aggregated response, z, by summing the individual responses, zⱼ;
generating a global challenge, c, by hashing at least the message to be signed, msg, and the aggregated commitment, w;
generating a hint, h, by:
determining a noisy commitment, y, by subtracting a product of the global challenge, c, and the portion of the public key, t, from a product of the aggregated response, z, and the public matrix, A; and
subtracting the noisy commitment, y, from the aggregated commitment, w, to generate the hint, h; and
outputting a signature comprising the global challenge, c, the aggregated response, z, and the hint, h.

6. A method according to claim 5 further comprising:
generating a commitment, cmtⱼ, that includes a hash of at least the generated learning with error sample, wⱼ, and
making the commitment, cmtᵢ, available in a first round of the signature method and making the learning with errors sample, wⱼ, available in a second round of the signature method;
wherein in a third round of the signature method, for each of the T secret shares, the step of generating the aggregated commitment, generating the challenge and generating the individual response are performed and each individual response, zⱼ, is made available in the third round.

7. A method according to claim 5 wherein:
generating T individual commitments, wᵢ, comprises for each of the T shares, generating a vector of learning with errors samples, \vec{wₗ}, and in a signing phase:
generating the aggregated commitment, w, comprises generating random weights, β, summing components of each vector of learning with errors samples with the random weights to generate a reduced individual commitment, wⱼ, and then summing the reduced individual commitments, wⱼ across the T secret shares to generate the aggregated commitment, w.

8. A method according to claim 5, further comprising:
for each of the T secret shares generating a first blinder and a second blinder associated with each secret share;
wherein generating the individual response, zⱼ, based on the challenge, c, the secret share, sⱼ, and one or more ephemeral randomness used to generate the one or more learning with errors sample, rⱼ comprises adding the first blinder; and
wherein generating an aggregated response, z, by summing the individual responses, zⱼ, comprises adding the second blinder associated with each secret share from the corresponding individual response to cancel the first blinder.

9. A method according to claim 8, wherein generating the first and second blinder comprises, for each of T secret shares being used to calculate the linear function:
generating one of the first blinder and the second blinder as a sum of a first set of T partial blinders, the first set of partial blinders being formed of a partial blinder generated in respect of a secret share for the secret share itself and T−1 partial blinders generated in respect of the secret share for respective ones of the T−1 other secret shares;
generating as the other of the first blinder and the second blinder a sum of partial blinders in a second set of partial blinders, the second set being formed of T partial blinders for the secret share including the partial blinder formed in respect of the secret share for the secret share.

10. A method according to claim 9, wherein each partial blinder is generated using a generator function, and the generator function takes a seed as an input and the method comprises for each of N secret shares:
1) generating N seeds including a seed in respect of the secret share and a seed for each of the respective other N−1 secret shares; and
2) distributing the N−1 seeds for other secret shares to the respective other secret shares so that each other secret share receives a single seed, wherein following completion of the two steps for all of the N secret shares, each secret share is associated with 2N−1 seeds including N seeds that were generated in respect of that secret share and N−1 seeds that have been received during the distributions and were generated for the secret share.

11. A method according to claim 10, wherein generating a blinder based on a seed comprises generating the blinder based on the output of a pseudorandom function to which the seed is input in combination with a session specific value.

12. A method according to claim 5 wherein generating the aggregate commitment, w, comprises dropping a predetermined number of bits from the sum.

13. A method according to claim 5 wherein the N secret shares are secret shares generated from the secret, s, using a Shamir secret sharing algorithm based on a polynomial of degree at most T−1, and:
generating an individual response for each secret share comprises taking a product of the challenge, c, a Lagrange coefficient, λⱼ, from the Shamir secret sharing algorithm associated with the secret share, sⱼ, and the secret share, sⱼ, and then combining the product the one or more ephemeral randomness, rⱼ, used to generate the one or more learning with errors sample.

14. A method according to claim 5 further comprising verifying the signature, wherein verifying the signature comprises:
generating a signature derived value that is a product of the public matrix, A, and the aggregated response, z, from the signature minus a product of the global challenge, c, from the signature and the portion of the public key, t;
generating a new challenge value, c′, by taking a hash of: the public key, vk, the message, msg, and the signature derived value plus the hint from the signature, h; and
comparing the new challenge value, c′, to the global challenge, c, to determine if the signature is valid.

15. A method according to claim 14, further comprising comparing a length of the aggregated response, z, and the hint, h, from the signature with one or more threshold, and wherein:
the signature is determined to be valid if the new challenge value, c′, is equal to the global challenge, c, from the signature; and
the length of the aggregated response and the hint are less than the one or more threshold.

16. A method according to claim 5, wherein generating each of the one or more learning with errors sample, wⱼ, comprises sampling the ephemeral randomness, rⱼ, and a small error, eⱼ, and generating the learning with errors sample, wⱼ, by adding the small error, eⱼ, to a product of the public matrix, A, and the ephemeral randomness, rⱼ.

17. A method according to claim 6 wherein generating a commitment, cmtⱼ, comprises generating a hash of the generated learning with error sample, wⱼ, and one or more of: the message, msg, and an identifier of the signer, act.

18. A method according to claim 5, wherein the following steps are performed by distributed multi-party computation:
generating a public matrix, A, and the secret, s;
generating a small noise, e, and a public key, vk=(A, t) for t that is a sum of the small noise, e, with a product of the public matrix, A, and the secret, s; and
generating N shared secrets from, sᵢ, from the secret, s.

19. One or more information processing apparatus, each comprising a processor and a storage medium storing computer-readable instructions, wherein the computer-readable instructions are configured to cause the one or more information processing apparatus to perform a method for calculating a linear function that includes a product of a secret, s, and a linear function component using a threshold number, T, out of a number N of secret shares generated from a secret, s, wherein the number of secret shares, N, is greater than the threshold number, T, the method comprising:
generating a public matrix, A, and the secret, s;
generating a small noise, e, and a public key, ek, that includes a sum of the small noise, e, with a product of the public matrix, A, and the secret, s;
generating N secret shares, s¿, from the secret, s;
for each of a threshold number, T, of the secret shares:
generating a blinder; and
generating masked shares of the calculation of the linear function by calculating a first component that is based on a product of the secret share, and the linear function component, and adding or subtracting from the first component a noise and the blinder; and
in an aggregating phase:
summing a combination of the masked share associated with each secret share, whereby the blinders cancel out over the sum of masked shares to allow determination of the linear function.

20. A non-transitory computer-readable storage medium storing a program that, when executed on one or more information processing apparatus cause the one or more information processing apparatus to perform a method for calculating a linear function that includes a product of a secret, s, and a linear function component using a threshold number, T, out of a number N of secret shares generated from a secret, s, wherein the number of secret shares, N, is greater than the threshold number, T, the method comprising:
generating a public matrix, A, and the secret, s;
generating a small noise, e, and a public key, ek, that includes a sum of the small noise, e, with a product of the public matrix, A, and the secret, s;
generating N secret shares, sᵢ, from the secret, s;
for each of a threshold number, T, of the secret shares:
generating a blinder; and
generating masked shares of the calculation of the linear function by calculating a first component that is based on a product of the secret share, and the linear function component, and adding or subtracting from the first component a noise and the blinder; and
in an aggregating phase:
summing a combination of the masked share associated with each secret share, whereby the blinders cancel out over the sum of masked shares to allow determination of the linear function.
